(19) United States
(12) Patent Application Publication
(10) Pub. No.: US 2026/0030820 A1
(43) Pub. Date: Jan. 29, 2026

(54) DETERMINING POSE INFORMATION OF CLOTH MODEL

(71) Applicant: Tencent Technology (Shenzhen) Company Limited, Shenzhen (CN)

(72) Inventors: Chun YUAN, Shenzhen (CN); Yunuo CHEN, Shenzhen (CN); Bo YANG, Shenzhen (CN)

(73) Assignee: Tencent Technology (Shenzhen) Company Limited, Shenzhen, GD (CN)

(21) Appl. No.: 19/342,436

(22) Filed: Sep. 26, 2025

Related U.S. Application Data
(63) Continuation of application No. PCT/CN2024/107618, filed on Jul. 25, 2024.

(30) Foreign Application Priority Data
Sep. 21, 2023 (CN) 202311229376.5

(51) Int. Cl. G06T 13/20; G06T 7/70

(52) U.S. Cl. CPC G06T 13/20; G06T 7/70; G06T 2210/16

(57) ABSTRACT

In a method, pose information of a cloth model is determined. A background grid is obtained based on uniformly dividing a two-dimensional plane that includes the cloth model. First motion information of each grid vertex indicating a motion state of each grid vertex at a first moment is acquired. An elastic energy function of the background grid indicating elasticity of the cloth model based on an elastic energy parameter is acquired. A target function indicating one or more constraints of the elastic energy function and the first motion information of each grid vertex is acquired. Second motion information of each grid vertex indicating a motion state of each grid vertex at a second moment later than the first moment is obtained based on the target function. First pose information of the cloth model is determined based on the second motion information of each grid vertex.

### RELATED APPLICATIONS

The present application is a continuation of International Application No. PCT/CN2024/107618, filed on Jul. 25, 2024, which claims priority to Chinese Patent Application No. 202311229376.5, filed on Sep. 21, 2023, and entitled “METHOD AND APPARATUS FOR DETERMINING POSE OF CLOTH, DEVICE, AND READABLE STORAGE MEDIUM.” The entire disclosures of the prior applications are hereby incorporated by reference.

### FIELD OF THE TECHNOLOGY

This disclosure relates to the technical field of cloth simulation, including a method and apparatus for determining pose information of a cloth model, a device, and a storage medium.

### BACKGROUND OF THE DISCLOSURE

With the development of technology, the cloth simulation technology has been widely applied in fields such as game development, animation production, and costume design. The cloth simulation technology is a technology that simulates state changes of cloth, such as stretching and twisting, in different environments by determining pose information of the cloth during motion.

In some applications, a cloth model may be constructed according to a three-dimensional modeling technology, and includes a plurality of cloth vertices. Differential equations for describing forces acting on the cloth vertices may be formulated and solved. In the solving process, energy transfer is performed according to a topological structure of the cloth vertices, to obtain motion information of the cloth vertices, and the pose information of the cloth model is determined based on the motion information of the cloth vertices.

### SUMMARY

This disclosure provides a method and apparatus for determining pose information of a cloth model, a device, and a storage medium, so as to simulate a motion of the cloth model through a background grid, which can improve computing efficiency and real-time performance of cloth simulation. Examples of technical solutions are as follows.

According to an aspect, a method for determining pose information of a cloth model is provided. A background grid is obtained based on uniformly dividing a two-dimensional plane, the two-dimensional plane including the cloth model. First motion information of each grid vertex in the background grid is acquired, the first motion information indicating a motion state of each grid vertex at a first moment. An elastic energy function of the background grid is acquired, the elastic energy function indicating elasticity of the cloth model based on an elastic energy parameter. A target function indicating one or more constraints of the elastic energy function and the first motion information of each grid vertex in the background grid is acquired. Second motion information of each grid vertex in the background grid is obtained based on the target function, the second motion information indicating a motion state of each grid vertex at a second moment, and the second moment being later than the first moment. First pose information of the cloth model is obtained based on the second motion information of each grid vertex.

According to an aspect, an apparatus for determining pose information of a cloth model is provided. The apparatus includes processing circuitry configured to obtain a background grid based on uniformly dividing a two-dimensional plane, the two-dimensional plane including the cloth model. The processing circuitry is configured to acquire first motion information of each grid vertex in the background grid, the first motion information indicating a motion state of each grid vertex at a first moment. The processing circuitry is configured to acquire an elastic energy function of the background grid, the elastic energy function indicating elasticity of the cloth model based on an elastic energy parameter. The processing circuitry is configured to acquire a target function indicating one or more constraints of the elastic energy function and the first motion information of each grid vertex in the background grid. The processing circuitry is configured to obtain second motion information of each grid vertex in the background grid based on the target function, the second motion information indicating a motion state of the grid vertex at a second moment, and the second moment being later than the first moment. The processing circuitry is configured to determine first pose information of the cloth model based on the second motion information of each grid vertex.

According to an aspect, a non-transitory computer-readable storage medium is provided. The non-transitory computer-readable storage medium stores instructions which when executed by a processor cause the processor to perform one or more operations for determining pose information of a cloth model. The one or more operations include obtaining a background grid based on uniformly dividing a two-dimensional plane, the two-dimensional plane including the cloth model. The one or more operations include acquiring first motion information of each grid vertex in the background grid, the first motion information indicating a motion state of each grid vertex at a first moment. The one or more operations include acquiring an elastic energy function of the background grid, the elastic energy function indicating elasticity of the cloth model based on an elastic energy parameter. The one or more operations include acquiring a target function indicating one or more constraints of the elastic energy function and the first motion information of each grid vertex in the background grid. The one or more operations include obtaining second motion information of each grid vertex in the background grid based on the target function, the second motion information indicating a motion state of the grid vertex at a second moment, and the second moment being later than the first moment. The one or more operations include determining first pose information of the cloth model based on the second motion information of each grid vertex.

According to an aspect, a method for determining pose information of a cloth model is provided. The method is performed by an electronic device, and includes: uniformly dividing a two-dimensional plane to obtain a background grid, the two-dimensional plane including the cloth model; acquiring first motion information of each grid vertex in the background grid, the first motion information of the grid vertex representing a motion state of the grid vertex at a first moment; acquiring an elastic energy function of the background grid, the elastic energy function describing elasticity of the cloth model by using an elastic energy parameter; acquiring a target function configured for constraining the elastic energy function and the first motion information of each grid vertex; obtaining second motion information of each grid vertex based on the target function, the second motion information of the grid vertex representing a motion state of the grid vertex at a second moment, and the second moment being later than the first moment; and determining first pose information of the cloth model based on the second motion information of each grid vertex.

According to an aspect, an apparatus for determining pose information of a cloth model is provided. The apparatus includes: a division module, configured to uniformly divide a two-dimensional plane to obtain a background grid, the two-dimensional plane including the cloth model; an acquiring module, configured to acquire first motion information of each grid vertex in the background grid, the first motion information of the grid vertex representing a motion state of the grid vertex at a first moment, the acquiring module being further configured to acquire an elastic energy function of the background grid, the elastic energy function describing elasticity of the cloth model by using an elastic energy parameter, and the acquiring module being further configured to acquire a target function configured for constraining the elastic energy function and the first motion information of each grid vertex; an obtaining module, configured to obtain second motion information of each grid vertex based on the target function, the second motion information of the grid vertex representing a motion state of the grid vertex at a second moment, and the second moment being later than the first moment; and a determining module, configured to determine first pose information of the cloth model based on the second motion information of each grid vertex.

According to an aspect, an electronic device is provided, including a processor and a memory, the memory having at least one computer program stored therein that, when loaded and executed by the processor, causing the electronic device to implement any one of the foregoing methods for determining pose information of a cloth model.

According to an aspect, a non-transitory computer-readable storage medium is further provided, the non-transitory computer-readable storage medium storing instructions which when executed by a processor cause the processor to implement any one of the foregoing methods for determining pose information of a cloth model.

According to an aspect, a computer program is further provided. There is at least one computer program. The at least one computer program is loaded and executed by a processor to cause an electronic device to implement any one of the foregoing methods for determining pose information of a cloth model.

According to another aspect, a computer program product is further provided, having at least one computer program stored therein. The at least one computer program is loaded and executed by a processor to cause an electronic device to implement any one of the foregoing methods for determining pose information of a cloth model.

In one or more examples provided in this disclosure, the two-dimensional plane in which the cloth model in a flattened state is located is uniformly divided to obtain a background grid, a target function is constructed based on the elastic energy function of the background grid and the first motion information of each grid vertex in the background grid, and the second motion information of each grid vertex is obtained by solving the target function, thereby simulating the motion of the cloth model through the background grid. Because the background grid is obtained through uniform division, the grid vertices in the background grid have the same shape, size, etc., and a topological structure of the background grid can be simplified, which can accelerate the efficiency of computing the second motion information of the grid vertices. In some examples, the first pose information of the cloth model is determined based on the second motion information of each grid vertex, such that a motion result of the background grid is transferred back to the cloth model, thereby more quickly and accurately obtaining a pose of the cloth model, and better ensuring real-time performance of cloth simulation.

### BRIEF DESCRIPTION OF THE DRAWINGS

FIG. 1 is a schematic diagram of an implementation environment of a method for determining pose information of a cloth model according to an embodiment of this disclosure.

FIG. 2 is a flowchart of a method for determining pose information of a cloth model according to an embodiment of this disclosure.

FIG. 3 is a schematic diagram of a background grid according to an embodiment of this disclosure.

FIG. 4 is a flowchart of another method for determining pose information of a cloth model according to an embodiment of this disclosure.

FIG. 5 is a schematic structural diagram of an apparatus for determining pose information of a cloth model according to an embodiment of this disclosure.

FIG. 6 is a schematic structural diagram of a terminal device according to an embodiment of this disclosure.

FIG. 7 is a schematic structural diagram of a server according to an embodiment of this disclosure.

### DESCRIPTION OF EMBODIMENTS

To make objectives, technical solutions, and advantages of this disclosure clearer, the following describes implementations of this disclosure in further detail with reference to the accompanying drawings.

In the technical field of cloth simulation, state changes of cloth, such as stretching and twisting, in different environments are typically simulated by determining pose information of the cloth during motion, and the technology has been widely applied in fields such as game development, animation production, and costume design.

In some applications, a cloth model may be constructed according to a three-dimensional modeling technology, and includes a plurality of cloth vertices. Next, differential equations for describing forces acting on the cloth vertices are formulated and solved. In the solving process, energy transfer is performed according to a topological structure of the cloth vertices, to obtain motion information of the cloth vertices, and the pose information of the cloth model is determined based on the motion information of the cloth vertices.

Each cloth vertex in the cloth model is topologically connected to form a plurality of triangular facets with non-fixed shapes and sizes, resulting in the complex topological structure of the cloth vertices and low efficiency of computing the motion information of the cloth vertices, consequently affecting the real-time performance of cloth simulation. In view of this, an embodiment of this disclosure provides a method for determining pose information of a cloth model. The method may determine pose information (e.g., first pose information described below) of the cloth model. In the method, a motion of the cloth model may be simulated through a background grid, thereby increasing computing efficiency.

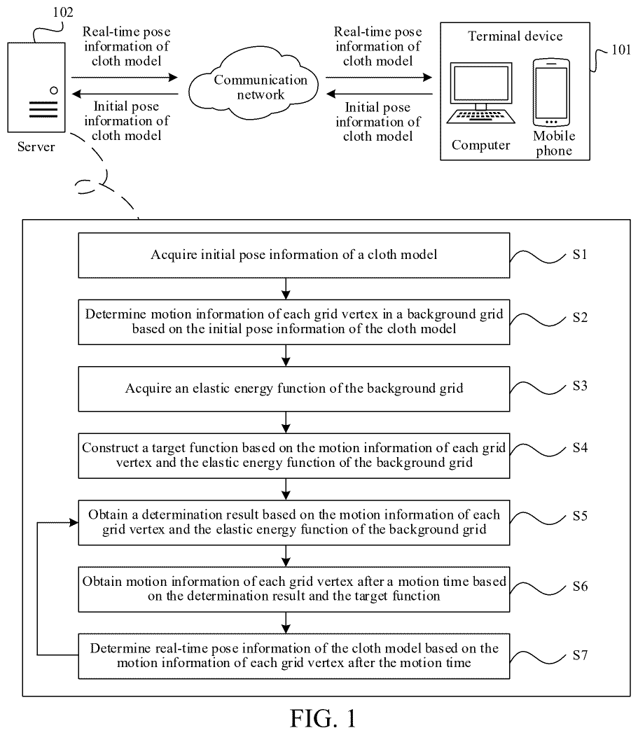

FIG. 1 is a schematic diagram of an implementation environment of a method for determining pose information of a cloth model according to an embodiment of this disclosure. As shown in FIG. 1, the implementation environment includes a terminal device 101 and a server 102. The method for determining pose information of a cloth model according to one or more embodiments of this disclosure may be performed by the terminal device 101, or the server 102, or jointly by the terminal device 101 and the server 102.

The terminal device 101 may be a smartphone, a game console, a desktop computer, a tablet computer, a laptop portable computer, a smart television, a smart in-vehicle device, a smart voice interaction device, a smart home appliance, or the like. The server 102 may be a single server, a server cluster formed by a plurality of servers, or any one of a cloud computing center or a virtualization center. This is not limited in this embodiment of this disclosure. The server 102 may be in communication connection with the terminal device 101 through a communication network. The server 102 may have functions of data processing, data storage, data transmission and reception, and the like. This is not limited in this embodiment of this disclosure. The number of terminal devices 101 and the number of servers 102 are not limited, and there may be one or more terminal devices and one or more servers.

In a possible implementation, the terminal device 101 transmits initial pose information of the cloth model to the server 102 through the communication network. The server 102 determines real-time pose information of the cloth model based on the initial pose information of the cloth model, and transmits the real-time pose information of the cloth model to the terminal device 101 through the communication network. The real-time pose information of the cloth model includes first pose information, second pose information, third pose information, and the like of the cloth model that are mentioned below.

In some embodiments, the server 102 determines the real-time pose information of the cloth model based on the initial pose information of the cloth model according to operation S1 to operation S7 shown below.

Operation S1: Acquire initial pose information of the cloth model.

Operation S2: Determine motion information of each grid vertex in a background grid based on the initial pose information of the cloth model. The background grid is obtained by uniformly dividing a two-dimensional plane in which the cloth model is located. In an example, the cloth model may be in a flattened state. The motion information of the grid vertices mentioned herein (for example, at S2) corresponds to first motion information of the grid vertices mentioned below. For details, reference may be made to related descriptions below, and details are not described herein again.

Operation S3: Acquire an elastic energy function of the background grid.

Operation S4: Construct a target function based on the motion information of each grid vertex and the elastic energy function of the background grid.

Operation S5: Obtain a determination result based on the motion information of each grid vertex and the elastic energy function of the background grid, the determination result corresponding to a first value of a second deformation gradient of each triangular facet that is mentioned below. For example, the elastic energy function of the background grid is solved based on the motion information of each grid vertex, to obtain a solution result. The solution result corresponds to the first value of the second deformation gradient of each triangular facet that is mentioned below. For details, reference may be made to related descriptions below, and details are not described herein again.

Operation S6: Obtain motion information of each grid vertex after a motion time based on the determination result and the target function. For example, the target function is solved based on the solution result, to obtain the motion information of each grid vertex after the motion time. The motion information of each grid vertex after the motion time mentioned herein corresponds to second motion information of the grid vertices mentioned below. For details, reference may be made to related descriptions below, and details are not described herein again.

Operation S7: Determine real-time pose information of the cloth model based on the motion information of each grid vertex after the motion time. The real-time pose information of the cloth model mentioned herein corresponds to the first pose information of the cloth model mentioned below. For details, reference may be made to related descriptions below, and details are not described herein again.

On one hand, the server 102 transmits the real-time pose information of the cloth model to the terminal device 101 through the communication network. On the other hand, the server 102 repeats operation S5 to operation S7. In this case, the solution result in operation S5 corresponds to a second value of the second deformation gradient of each triangular facet that is mentioned below, the motion information of each grid vertex after the motion time that is mentioned in operation S6 corresponds to third motion information of each grid vertex that is mentioned below, and the real-time pose information of the cloth model that is mentioned in operation S7 corresponds to the second pose information of the cloth model that is mentioned below.

Next, the server 102 transmits the real-time pose information of the cloth model to the terminal device 101 again through the communication network, and performs operation S5 to operation S7 for updating real-time pose information, and so on. That is, the server 102 cyclically performs operation S5 to operation S7, to determine the motion information of each grid vertex in real time, and determine the pose information of the cloth model based on the motion information of each grid vertex, to ensure real-time performance of a cloth simulation process.

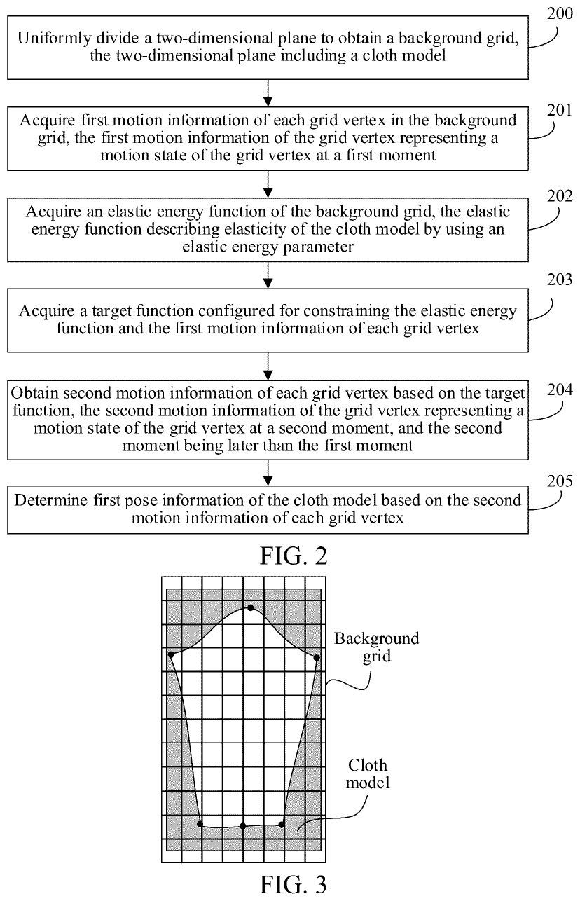

A flowchart of a method for determining pose information of a cloth model according to an embodiment of this disclosure shown in FIG. 2 is used as an example. For ease of description, the terminal device or the server that performs the method for determining pose information of a cloth model according to this embodiment of this disclosure is referred to as an electronic device. The method may be performed by the electronic device. As shown in FIG. 2, the method includes the following operations.

Operation 200: Uniformly divide a two-dimensional plane to obtain a background grid, the two-dimensional plane including the cloth model.

In this embodiment of this disclosure, the cloth model is a model configured for representing cloth, and may be obtained by modeling through a three-dimensional modeling technology. The cloth model includes a plurality of cloth vertices and a plurality of cloth facets, and one cloth facet is in a shape of a geometrical facet, with vertices being the cloth vertices. In some examples, one or more of the cloth facets are triangular facets. Because the cloth model may be of any shape, size, or the like, the distribution of the cloth vertices in the cloth model may be in any topological form, and the cloth facets in the cloth model are not regularly distributed. Any cloth facet may be of any size, any shape, or the like. For example, the cloth facet may be a right triangle, an acute triangle, an obtuse triangle, an isosceles triangle, or the like.

In some examples, the cloth model is in a flattened state. That is, the two-dimensional plane includes the cloth model in the flattened state. That is, the two-dimensional plane in which the cloth model in the flattened state is located may be uniformly divided, to obtain the background grid. The background grid includes a plurality of grid vertices and a plurality of grid facets, and one grid facet is in a shape of a geometrical facet, with vertices being the grid vertices. Because the background grid is obtained through uniform division, the grid facets in the background grid are regularly distributed, that is, any two grid facets are the same in size, shape, and the like. In some embodiments, each grid facet is in a square shape. In an example, the cloth model in the flattened state can be accommodated by the two-dimensional plane, and different grid facets included in the background grid correspond to different parts in the cloth model. Therefore, each part in the cloth model has a corresponding grid facet, so as to subsequently determine the first pose information of the cloth model based on the background grid.

Referring to FIG. 3, FIG. 3 is a schematic diagram of a background grid according to an embodiment of this disclosure. The cloth model in the flattened state has a rectangular outer periphery, with a hollowed-out center. The hollowed-out geometric shape is irregular. The two-dimensional plane in which the cloth model in the flattened state is located is uniformly divided to obtain the background grid, and the background grid includes a plurality of quadrilaterals of the same shape and size.

Operation 201: Acquire first motion information of each grid vertex in the background grid, the first motion information of the grid vertex representing a motion state of the grid vertex at a first moment (for example, at time t1). In one example, the first motion information indicates a motion state of each grid vertex at a first moment.

The motion state of each grid vertex at the first moment includes at least one of a location, a speed, an acceleration, or a momentum of the grid vertex at the first moment. In this embodiment of this disclosure, the first motion information of each grid vertex in the background grid may be first acquired. The first motion information of each grid vertex includes, but is not limited to, at least one motion parameter of first location information, a first speed, a first acceleration, or a first momentum of the grid vertex. A motion made by each grid vertex at the first moment is described by using the at least one motion parameter, where the first moment is any moment.

In some examples, when the first motion information of the grid vertex includes the first location information, the represented motion state includes a location of the grid vertex at the first moment. When the first motion information includes the first speed, the represented motion state includes a speed of the grid vertex at the first moment. When the first motion information includes the first acceleration, the represented motion state includes an acceleration of the grid vertex at the first moment (i.e., a rate of change of speed). When the first motion information includes the first momentum, the represented motion state includes a momentum of the grid vertex at the first moment (i.e., a tendency of the grid vertex to maintain the motion in a motion direction of the grid vertex).

This embodiment of this disclosure does not limit a manner for acquiring the first motion information of the grid vertices. In some examples, the first motion information of the grid vertices is generated in various manners. In some examples, the first motion information of the grid vertices is inputted by a user. In some examples, when the cloth model collides with an object model, the motion information of the cloth vertices in the cloth model changes, and the motion information of the grid vertices in the background grid also changes as the motion information of the cloth vertices changes. That is, the motion information of the grid vertices is related to the motion information of the cloth vertices. Based on this, the electronic device may acquire initial pose information of the cloth model. The initial pose information of the cloth model may describe a pose, such as a shape, distortion, or stretching, of the cloth model when the cloth model collides with the object model. The initial pose information of the cloth model includes the first motion information of each cloth vertex, and the first motion information of the grid vertices is determined based on the first motion information of the cloth vertices.

The object model may be any model. For example, the object model may be a sand model, a snow accumulation model, an elastic body model, a cloth model, a hair model, or the like. If the cloth model collides with another cloth model, the collision may be referred to as inter-cloth collision. If one part of the cloth model collides with another part of the cloth model, the collision may be referred to as cloth self-collision. If the cloth model collides with an object model other than the cloth model, the collision may be referred to as collision between the cloth and another object.

In at least one implementation, the cloth model includes a plurality of cloth vertices. As shown in FIG. 3, after the two-dimensional plane in which the cloth model in the flattened state is located is uniformly divided to obtain the background grid, the background grid includes a plurality of grid vertices. Because the cloth model includes the plurality of cloth vertices, one cloth vertex may overlap with one grid vertex, or may not overlap with any grid vertex.

In some examples, at Operation 201 for any grid vertex in the background grid (for example, a given grid vertex, the processing of the given grid vertex is applicable to other grid vertexes in the background grid), first motion information of a cloth vertex in the cloth model is determined as first motion information of the any grid vertex (for example, the given grid vertex introduced above, the processing of the given grid vertex is applicable to other grid vertexes in the background grid), when the grid vertex overlaps with the cloth vertex. In some examples, at Operation 201 for the grid vertex in the background grid, one or more reference cloth vertexes related to the grid vertex is determined from the plurality of cloth vertices and the first motion information of the grid vertex is obtained based on first motion information of the one or more reference cloth vertexes, when the grid vertex in the background grid does not overlap with any of the plurality of cloth vertices in the cloth model. In at least one example, the first motion information of the grid vertex is obtained based on performing interpolation on the first motion information of the one or more reference cloth vertexes.

If one cloth vertex overlaps with one grid vertex, the first motion information of the cloth vertex is the first motion information of the grid vertex. If one cloth vertex does not overlap with any grid vertex, a plurality of cloth vertices located around one grid vertex in the cloth model that is in the flattened state are cloth vertices related to the grid vertex, and the first motion information of the grid vertex is obtained by performing, for example, interpolation on the first motion information of each cloth vertex related to the grid vertex. The first motion information of the grid vertex is determined through the first motion information of the cloth vertices, such that the background grid has motion performance of the cloth model, thereby allowing the background grid to simulate the motion of the cloth model, and thus determining a pose of the cloth model.

The first motion information of the cloth vertex includes, but is not limited to, at least one motion parameter of first location information, a first speed, a first acceleration, or a first momentum of the cloth vertex. A motion of the cloth vertex is described by using the at least one motion parameter. This embodiment of this disclosure does not limit a manner for acquiring the first motion information of the cloth vertex, or a manner for performing interpolation on the first motion information of each cloth vertex. In some examples, the interpolation is performed on the first motion information of each cloth vertex by using at least one of a nearest neighbor interpolation method, a bilinear interpolation method, or a quadratic B-spline interpolation method.

Operation 202: Acquire an elastic energy function of the background grid, the elastic energy function describing elasticity of the cloth model by using an elastic energy parameter.

In some examples, the elastic energy function is configured for describing stored energy in a case that the background grid has elastic performance of the cloth model. In other words, the elastic energy function is configured for describing the elastic energy parameter of the background grid, and the elastic energy parameter is configured for the background grid to simulate the cloth model with corresponding elastic performance. In some embodiments, the energy stored in the background grid may be understood as the elastic energy parameter of the background grid. In other words, in some examples the background grid may only have the corresponding elastic energy parameter, without storing real physical energy. The elastic energy parameter is configured for the background grid to simulate the corresponding cloth model with the elastic performance. For example, the elastic energy parameter is a value of elastic energy, which represents energy stored due to elastic deformation of the cloth model (with corresponding elastic performance). In an example, in a process of displaying the background grid (including at least one pixel), a display parameter (including but not limited to at least one of a color, contrast, brightness, or the like) corresponding to the at least one pixel may be determined according to the elastic energy parameter of the background grid, and the background grid is displayed according to the display parameter corresponding to the at least one pixel, such that the displayed background grid can exhibit an elastic property. For example, when watching the displayed background grid, the user considers that the background grid is an elastic material, thereby simulating the cloth model (with corresponding elastic performance) by the background grid.

In this embodiment of this disclosure, the electronic device may determine the elastic energy function of the background grid based on an elastic performance parameter of the cloth model and the first motion information of each grid vertex. Through the elastic energy function of the background grid, the elastic energy stored in the background grid is simulated in a case that the background grid has the elastic performance of the cloth model (i.e., the background grid has the foregoing elastic energy parameter), thereby allowing the background grid to simulate traction force between the cloth vertices in the cloth model, and thus simulating changes in the pose of the cloth model. This embodiment of this disclosure does not limit the elastic performance parameter of the cloth model. In some examples, the elastic performance parameter of the cloth model includes at least one of a tensile strength or an elastic modulus.

That is, operation 202 may include: determining the elastic energy function of the background grid based on the elastic performance parameter of the cloth model and the first motion information of each grid vertex, where the elastic performance parameter includes at least one of a tensile strength or an elastic modulus, and the first motion information includes at least one motion parameter of first location information, a first speed, a first acceleration, or a first momentum.

In a possible implementation, the background grid includes a plurality of grid facets. Since each grid facet includes a plurality of grid vertices and any three grid vertices in the grid facet may form a triangular facet, each grid facet includes at least one triangular facet. For example, when the grid facet is in a square shape, one grid facet may be folded into two triangular facets. For any grid facet included in the background grid, the any grid facet includes a plurality of grid vertices, and the any grid facet includes at least one triangular facet, with the vertices of any triangular facet being the grid vertices. In this case, operation 202 includes operation 2021 to operation 2022 (not shown). For example, in a case that operation 202 includes determining the elastic energy function of the background grid based on the elastic performance parameter of the cloth model and the first motion information of each grid vertex, the elastic performance parameter includes the tensile strength, and the first motion information includes the first location information, the determining the elastic energy function of the background grid based on the elastic performance parameter of the cloth model and the first motion information of each grid vertex includes operation 2021 to operation 2022.

Operation 2021: For any triangular facet, determine an elastic energy density of the any triangular facet based on a tensile strength of the any triangular facet and first location information of each grid vertex in the any triangular facet, the elastic energy density of the any triangular facet being configured for describing elasticity of a sub-cloth model, and the sub-cloth model being a part corresponding to any triangular facet in the cloth model. In one example, for each triangular facet, an elastic energy density of the corresponding triangular facet is determined based on the tensile strength of the corresponding triangular facet and the first location information of the grid vertexes of the corresponding triangular facet, the elastic energy density of the corresponding triangular facet indicating elasticity of a sub-cloth model, and the sub-cloth model being a part of the cloth model corresponding to the corresponding triangular facet.

In some examples, the elastic energy density of the any triangular facet represents elastic energy stored in the any triangular facet. In some embodiments, the elastic energy stored in the triangular facet may be understood as the elastic energy density of the triangular facet. In other words, in some examples, the triangular facet may only have a corresponding elastic energy density, without storing real physical energy. Because the triangular facet belongs to the grid facet, and the grid facet belongs to the background grid, the background grid hence includes the triangular facet. As indicated in operation 200 above, the background grid is obtained by dividing the two-dimensional plane in which the cloth model is located. Therefore, the background grid corresponds to the cloth model, and the triangular facets included in the background grid correspond to the sub-cloth models included in the cloth model, and each sub-cloth model is a part corresponding to any triangular facet in the cloth model.

In this embodiment of this disclosure, the tensile strength of the triangular facet is configured for representing a value of transition from uniform plastic deformation to locally concentrated plastic deformation of the triangular facet in a case that the triangular facet has the elastic performance of the cloth model (or, in a case that the triangular facet has the corresponding elastic energy density and can simulate the sub-cloth model having the corresponding elastic performance). In brief, the tensile strength of the triangular facet is a maximum bearing capability of the triangular facet in a static stretching condition, namely a maximum uniform plastic deformation resistance of the triangular facet. In this embodiment of this disclosure, the tensile strength of any triangular facet is a set tensile strength of the cloth model. Based on this, the tensile strengths of any two triangular facets are the same.

The electronic device may acquire the first motion information of each grid vertex. The first motion information of any grid vertex includes the first location information of the grid vertex, and the first location information of the grid vertex represents coordinates of the grid vertex in a three-dimensional space. Based on this, the electronic device may determine the first location information of each grid vertex in any triangular facet.

Next, the electronic device determines the elastic energy density of the triangular facet based on the tensile strength of the any triangular facet and the first location information of each grid vertex in the triangular facet. The elastic energy density of the triangular facet is configured for representing elastic energy stored per unit area within an elastic material when an area of the triangular facet is taken as the unit area (e.g., the sub-cloth model corresponding to the triangular facet, which has the corresponding elastic performance). Because the triangular facet has the elastic performance of the cloth model, the triangular facet is the elastic material and may store specific elastic energy. That is, the triangular facet has the corresponding elastic energy density, and can simulate the foregoing elastic material. No further examples will be elaborated here.

In some embodiments, operation 2021 includes operation A1 to operation A3 (not shown).

Operation A1: Determine an area and a first deformation gradient of any triangular facet based on first location information of each grid vertex in the any triangular facet.

In this embodiment of this disclosure, a length of each side in the triangular facet may be determined based on the first location information of each grid vertex in the triangular facet, so as to determine a shape and a size of the triangular facet. On one hand, the area of the triangular facet is determined based on the length of each side in the triangular facet, and a size of a two-dimensional space occupied by the triangular facet is described through the area of the triangular facet. On the other hand, the first deformation gradient of the triangular facet is determined based on the length of each side in the triangular facet and the first location information of each grid vertex in the triangular facet, and a deformation manner of the triangular facet is described through the first deformation gradient of the triangular facet. That is, operation A1 may include: determining the length of each side in the any triangular facet based on the first location information of each grid vertex in the any triangular facet; determining the area of the any triangular facet according to the length of each side of the any triangular facet; and determining a first deformation gradient of the any triangular facet according to the length of each side in the any triangular facet and the first location information of each grid vertex in the any triangular facet.

In some embodiments, any triangular facet has two sides that are perpendicular to each other and have the same length; and the length of each side in the foregoing any triangular facet includes a length of a target side, and the target side is one of the two sides that are perpendicular to each other and have the same length. Correspondingly, operation A1 includes: determining the length of the target side based on the first location information of each grid vertex in any triangular facet, the target side being one of the two sides that are perpendicular to each other and have the same length; determining the area of the any triangular facet based on the length of the target side; and determining the first deformation gradient of the any triangular facet based on the length of the target side and the first location information of each grid vertex in the any triangular facet.

If the triangular facet has two sides that are perpendicular to each other and have the same length, the shape of the triangular facet is an isosceles right triangle. The electronic device may determine the length of each side in the triangular facet based on the first location information of each grid vertex in the triangular facet, and select two equal lengths from the lengths of the sides, so as to obtain the length of the target side.

Assuming that the first location information of the three grid vertices of the triangular facet f is

$$\{ {X}_{0}^{f} , {X}_{1}^{f} , {X}_{2}^{f} \} ,$$

when the shape of the triangular facet is the isosceles right triangle,

$$( {X}_{1}^{f} - {X}_{0}^{f} ) ⊥ ( {X}_{2}^{f} - {X}_{0}^{f} ) , ‖ {X}_{2}^{f} - {X}_{0}^{f} ‖ = ‖ {X}_{1}^{f} - {X}_{0}^{f} ‖ = s$$

is satisfied, s representing the length of the target side. If the grid facet is in a square shape, s also represents the side length of the grid facet.

On one hand, the area

$${A}_{f} = \frac{{s}^{2}}{2}$$

of the triangular facet may be determined based on the length s of the target side. On the other hand, the first deformation gradient

$${F}^{f} = \frac{[ {X}_{1}^{f} - {X}_{0}^{f} , {X}_{2}^{f} - {X}_{0}^{f} ]}{s}$$

of the triangular facet may be determined based on the length s of the target side and the first location information

$$\{ {X}_{0}^{f} , {X}_{1}^{f} , {X}_{2}^{f} \}$$

of each grid vertex in the triangular facet.

Operation A2: Determine a second deformation gradient of the any triangular facet based on the first deformation gradient of the any triangular facet, the second deformation gradient of the any triangular facet is based on applying a value constraint to the first deformation gradient of the any triangular facet.

In this embodiment of this disclosure, the value constraint may be performed on the first deformation gradient of the triangular facet, to obtain the second deformation gradient of the triangular facet. The value constraint is configured for reflecting a deformation constraint on the triangular facet. Therefore, a deformation manner of the triangular facet in a case that the deformation constraint exists is described through the second deformation gradient of the triangular facet. There may be a plurality of manners for performing the value constraint on the first deformation gradient of the triangular facet. The following shows a possible implementation, and other implementations are not described herein again.

In some embodiments, operation A2 includes: performing singular value decomposition on the first deformation gradient of any triangular facet, to obtain a first orthogonal matrix, a first diagonal matrix, and a second orthogonal matrix; replacing the first diagonal matrix with a second diagonal matrix, the second diagonal matrix is based on applying the value constraint to the first diagonal matrix; and determining a second deformation gradient of the any triangular facet based on the first orthogonal matrix, the second diagonal matrix, and the second orthogonal matrix.

In this embodiment of this disclosure, singular value decomposition (SVD) may be performed on the first deformation gradient F^{f} of the triangular facet to obtain the first orthogonal matrix U, the first diagonal matrix Σ, and the second orthogonal matrix V^{T}, namely F^{f}=UΣV^{T}. The first orthogonal matrix U is a left singular vector, the first diagonal matrix E is a singular value, and the second orthogonal matrix V^{T} is a right singular vector. The first orthogonal matrix U is an M & M matrix, the first diagonal matrix Σ is an M×N matrix, the second orthogonal matrix V^{T} is an N× N matrix, M and N are both positive integers, and M and N are the same or different.

Next, a constraint function is used to apply a strain constraint to the first diagonal matrix in a principal direction (i.e., a direction corresponding to the singular vector, which may refer to at least one of a direction corresponding to the left singular vector or a direction corresponding to the right singular vector), resulting in the second diagonal matrix. In some embodiments, the constraint function is a clamp ( ) function, and a known maximum value and a known minimum value may be used to constrain a strain range through the clamp ( ) function. In this way, the first diagonal matrix Σ is replaced with the second diagonal matrix J. In some embodiments, the second diagonal matrix satisfies

$$J = [ \begin{matrix}1 & 0 \\ 0 & 1 \\ 0 & 0\end{matrix} ] .$$

Then, through the first orthogonal matrixU, the second diagonal matrix) and the second orthogonal matrixV^{T}, the second deformation gradient R^{f} of any triangular facet is determined, namely R^{f}=UJV^{T}.

Operation A3: Determine the elastic energy density of the any triangular facet based on the tensile strength, the area, the first deformation gradient, and the second deformation gradient of the any triangular facet.

In this embodiment of this disclosure, the elastic energy density e^{f}(X) of the triangular facet may be determined based on the tensile strength

$${C}_{st}^{f} ,$$

the area A_{f}, the first deformation gradient F^{f}, and the second deformation gradient R^{f} of the triangular facet according to the formula (1) shown below.

$${e}^{f} ( X ) = {C}_{st}^{f} {A}_{f} {min}_{{R}^{f} ∈ {SU}_{3 \times 2}} {‖ {F}^{f} - {R}^{f} ‖}^{2} \qquad Formula ( 1 )$$

where SU_{3×2}={[z₁, z₂]∈Mat_{3×2}:z₁ ⊥z₂, ∥z₁∥=∥z₂∥=1}. Mat is an abbreviation of Matrix, and therefore Mat_{3×2} represents a 3×2 matrix, and SU_{3×2} includes a plurality of Mat_{3×2}. One Mat_{3×2} is configured for describing one isosceles right triangle, and the isosceles right triangle has sides z₁ and z₂ that are perpendicular to each other and have lengths of 1.

$${min}_{{R}^{f} ∈ S {U}_{3 \times 2}} {‖ {F}^{f} - {R}^{f} ‖}^{2}$$

has an analytic solution. The elastic energy density of the triangular facet is a function related to the second deformation gradient of the triangular facet, and a relationship between the second deformation gradient of the triangular facet and the elastic energy density of the triangular facet is restricted through the tensile strength, the area, and the first deformation gradient of the triangular facet.

The foregoing formula (1) is designed according to projective dynamic. In a practical application, the elastic energy density of the triangular facet may also be designed by using another principle. Details are not described in this embodiment of this disclosure.

Operation 2022: Determine an elastic energy function of the background grid based on the elastic energy density of each triangular facet.

In this embodiment of this disclosure, the elastic energy density of each triangular facet may be added to obtain the elastic energy function of the background grid. In some embodiments, the elastic energy function Eₑₗₛ(X) of the background grid is shown as the following formula (2).

$${E}_{e l s} ( X ) = {\sum }_{f ∈ all triangular facets} {e}^{f} ( X ) = {\sum }_{f ∈ all triangular facets} {C}_{st}^{f} {A}_{f} {min}_{{R}^{f} ∈ {SU}_{3 \times 2}} {‖ {F}^{f} - {R}^{f} ‖}^{2} \qquad Formula ( 2 )$$

If the cloth model does not have a bending effect, the foregoing formula (2) may be used to construct the elastic energy function of the background grid. That is, in a case that the cloth model does not have the bending effect, operation 2022 includes: adding the elastic energy densities of the plurality of triangular facets, to obtain the elastic energy function of the background grid. If the cloth model has the bending effect, the following implementation may be used to construct the elastic energy function of the background grid.

In some examples, operation 2022 includes: acquiring a bending strength and a mean curvature of the cloth model; and determining the elastic energy function of the background grid based on the bending strength and the mean curvature of the cloth model, and the elastic energy density of each triangular facet.

In this embodiment of this disclosure, the bending strength of the cloth model is configured for describing a maximum stress that the cloth model can bear when the cloth model cracks or reaches a specified bending moment under a bending load. Through the bending strength of the cloth model, the bending resistance of the cloth can be reflected, and the bending performance of the cloth can be measured. The mean curvature of the cloth model is configured for describing a curvature of a curved surface of the cloth model that is embedded in a surrounding space.

This embodiment of this disclosure does not limit a manner for acquiring the bending strength and the mean curvature of the cloth model. In some examples, the electronic device may acquire a configuration file of the cloth model. The configuration file includes the bending strength and the mean curvature of the cloth model. In some examples, the electronic device may determine the bending strength and the mean curvature of the cloth model according to a cloth material. In some examples, the electronic device may acquire the bending strength and the mean curvature of the cloth model that are inputted by the user.

According to the formula (3) shown below, the elastic energy function Eₑₗₛ(X) of the background grid may be determined based on the bending strength C_{bd} and the mean curvature Q of the cloth model, as well as the elastic energy density e^{f}(X) of each triangular facet. X represents location information of each grid vertex in the background grid, and is an independent variable.

$${E}_{e l s} ( X ) = {\sum }_{f ∈ all triangular facets} {e}^{f} ( X ) + {C}_{b d} \frac{1}{2} {X}^{T} Q X \qquad Formula ( 3 )$$

Operation 203: Acquire a target function configured for constraining the elastic energy function and the first motion information of each grid vertex. In one example, a target function indicating one or more constraints of the elastic energy function and the first motion information of each grid vertex in the background grid is acquired.

This embodiment of this disclosure does not limit a form of the target function. In some examples, in addition to including the elastic energy function of the background grid and the first motion information of each grid vertex, the target function may also include at least one motion parameter of a motion time, a gravitational acceleration, or a wind speed. The target function is a function related to the second deformation gradient of each triangular facet and a location variable of each grid vertex. Second motion information of each grid vertex may be obtained based on the target function. For example, the second motion information of each grid vertex may be obtained by solving the target function. For another example, there is a correspondence between the target function and the second motion information, and the second motion information corresponding to the target function is determined as the second motion information of each grid vertex.

In a possible implementation, operation 203 includes operations 2031 to 2033 (not shown).

Operation 2031: Determine a reference location of each grid vertex based on the first motion information of each grid vertex and a gravitational acceleration, the reference location of any grid vertex (for example, each grid vertex) being configured for describing a location of the any grid vertex after the motion under the influence of gravity.

In this embodiment of this disclosure, the electronic device may determine the reference location of each grid vertex based on the first motion information of each grid vertex and the gravitational acceleration according to a kinematic principle. In some embodiments, the first motion information of the grid vertex includes first location information of the grid vertex and a first speed of the grid vertex, and according to sⁿ=xⁿ+hvⁿ+h²g, a reference location of each grid vertex is determined, where s represents the reference location of the grid vertex, x represents the first location information of the grid vertex, v represents the first speed of the grid vertex, g represents the gravitational acceleration, n represents the number of grid vertices, and h represents the motion time. This embodiment of this disclosure does not limit a manner for acquiring the motion time. In some examples, the motion time is a parameter inputted by the user, or the motion time is a parameter randomly generated, or the motion time is a set parameter.

Operation 2032: Determine a reference energy function of the background grid that is configured for constraining a cloth mass corresponding to the cloth model and the reference location of each grid vertex.

In this embodiment of this disclosure, the electronic device may determine the reference energy function of the background grid based on the cloth mass M corresponding to the cloth model and the reference location s″ of each grid vertex. There may be a plurality of manners for determining the reference energy function of the background grid. In a possible implementation, the reference energy function of the background grid is:

$$\frac{1}{2} {( {x}^{*} - {s}^{n} )}^{T} M ( {x}^{*} - {s}^{n} ) .$$

Other implementations are not described herein again. T is a symbol of a transposed matrix, and x* is an independent variable configured for representing the location information of each grid vertex. That is, x* represents a location variable of each grid vertex.

The reference energy function of the background grid is a function related to the location variable of the grid vertex. A relationship between the location variable of each grid vertex and the reference energy function of the background grid is restricted by the cloth mass and the reference location of each grid vertex.

Operation 2033: Construct a target function based on the reference energy function of the background grid and the elastic energy function of the background grid.

In this embodiment of this disclosure, the target function may be obtained by performing operations such as addition or weighted calculation on the reference energy function of the background grid and the elastic energy function of the background grid. In some embodiments, the target function E (x*) satisfies:

$$E ( {x}^{*} ) : = \frac{1}{2} {( {x}^{*} - {s}^{n} )}^{T} M ( {x}^{*} - {s}^{n} ) + {h}^{2} {E}_{e l s} ( {x}^{*} ) ,$$

h represents the motion time, and: =represents “defined as.” When the target function is constructed, the target function may also be constructed based on other energy information, which is not limited herein.

Operation 204: Obtain second motion information of each grid vertex based on the target function, the second motion information of the grid vertex representing (or indicating) a motion state of the grid vertex at a second moment (for example, at time t2), and the second moment being later than the first moment (for example, time t2 is after time t1).

Because the target function is constructed through the reference energy function of the background grid and the elastic energy function of the background grid, the target function is a function related to the location variable of the grid vertex and the second deformation gradient of the triangular facet. The cloth mass, the reference location of each grid vertex, and the tensile strength, the area, and the first deformation gradient of each triangular facet constrain a relationship between the location variable of each grid vertex, the second deformation gradient of each triangular facet, and the target function.

Based on the target function (e.g., by solving the target function), the second motion information of each grid vertex shown in the following formula (4) may be obtained. xⁿ⁺¹ represents the second location information of each grid vertex, x* is configured for describing the location variable of each grid vertex, and argmin represents a value xⁿ⁺¹ of the independent variable x* that minimizes the target function E(x*).

$${x}^{n + 1} = arg {min}_{x} * E ( {x}^{*} ) : = \frac{1}{2} {( {x}^{*} - {s}^{n} )}^{T} M ( {x}^{*} - {s}^{n} ) + {h}^{2} {E}_{e l s} ( {x}^{*} ) \qquad Formula ( 4 )$$

In this embodiment of this disclosure, the foregoing formula (4) is obtained by means of reasoning in the following manner.

First, the second location information xⁿ⁺¹ of each grid vertex and the second speed vⁿ⁺¹ of each grid vertex satisfy the formula (41) and the formula (42) shown below.

$${x}^{n + 1} = {x}^{n} + h {v}^{n + 1} \qquad Formula ( 41 )$$

$${v}^{n + 1} = {v}^{n} + h {M}^{- 1} {f}_{e l s} ( {x}^{n + 1} ) + h g \qquad Formula ( 42 )$$

xⁿ ∈R³ⁿ represents the first location information of each grid vertex. vⁿ ∈R³ⁿ represents the first speed of each grid vertex. fₑₗₛ(xⁿ⁺¹)∈R³ⁿ represents the elastic force of the background grid, and is a parameter related to the second location information xⁿ⁺¹ of each grid vertex. g∈R³ⁿ represents the gravitational acceleration. R represents a real number, R³ⁿ represents a 3n-dimensional matrix formed by real numbers, n represents the number of grid vertices, h represents the motion time, and M represents the cloth mass.

The foregoing formula (41) and formula (42) belong to nonlinear equations. To solve the nonlinear equations, it may be assumed that the elastic force of the background grid is a negative gradient of the elastic energy Eₑₗₛ of the background grid (referred to as the elastic energy parameter in one example), namely fₑₗₛ=−∇Eₑₗₛ. In this case, the foregoing nonlinear equations may be rewritten as the following equations, namely the formula (43) and the formula (44).

$${x}^{n + 1} = {argmin}_{{x}^{*}} \frac{1}{2} {( {x}^{*} - {s}^{n} )}^{T} M ( {x}^{*} - {s}^{n} ) + {h}^{2} {E}_{e l s} ( {x}^{*} ) \qquad Formula ( 43 )$$

$${v}^{n + 1} = \frac{{x}^{n + 1} - {x}^{n}}{h} \qquad Formula ( 44 )$$

The first equation (i.e., the formula (43)) in the foregoing equations is the formula (4) mentioned above. The second location information xⁿ⁺¹ of each grid vertex may be determined through the formula (4). The second speed vⁿ⁺¹ of each grid vertex may be determined based on the second location information xⁿ⁺¹ of each grid vertex, the first location information xⁿ of each grid vertex, and the motion time.

If the cloth model does not have the bending effect, the formula (4) mentioned above is equivalent to the formula (5) shown below.

$${min}_{{x}^{*}} E ( {x}^{*} ) := \frac{1}{2} {( {x}^{*} - {s}^{n} )}^{T} M ( {x}^{*} - {s}^{n} ) + {h}^{2} {\sum }_{f ∈ all triangular facets} {C}_{st}^{f} {A}_{f} {min}_{{R}^{f} ∈ {SU}_{3 \times 2}} {‖ {F}^{f} - {R}^{f} ‖}^{2} \qquad Formula ( 5 )$$

Based on the principle of an alternative direction method, the foregoing formula (5) may be transformed into the formula (6) show below.

$${min}_{{x}^{*} , \{ {R}^{f} \}} \frac{1}{2} {( {x}^{*} - {s}^{n} )}^{T} M ( {x}^{*} - {s}^{n} ) + {h}^{2} {\sum }_{f ∈ all triangular facets} C {}_{st}^{f} {A}_{f} {‖ {F}^{f} - {R}^{f} ‖}^{2} \qquad Formula ( 6 )$$

If the cloth model has the bending effect, the formula (4) mentioned above is equivalent to the formula (7) shown below.

$${min}_{{x}^{*}} E ( {x}^{*} ) := \frac{1}{2} {( {x}^{*} - {s}^{n} )}^{T} M ( {x}^{*} - {s}^{n} ) + {h}^{2} ( {\sum }_{f ∈ all triangular facets} {C}_{s f}^{f} {A}_{f} {min}_{{R}^{f} ∈ {SU}_{3 \times 2}} {‖ {F}^{f} - {R}^{f} ‖}^{2} + {C}_{b d} \frac{1}{2} {{x}^{*}}^{T} {Qx}^{*} ) \qquad Formula ( 7 )$$

Based on the principle of the alternative direction method, the foregoing formula (7) may be transformed into the formula (8) shown below.

$${min}_{{x}^{*} , \{ {R}^{f} \}} \frac{1}{2} {( {x}^{*} - {s}^{n} )}^{T} M ( {x}^{*} - {s}^{n} ) + {h}^{2} ( {\sum }_{f ∈ all triangular facets} {C}_{st}^{f} {A}_{f} {‖ {F}^{f} - {R}^{f} ‖}^{2} + {C}_{b d} \frac{1}{2} {{x}^{*}}^{T} {Qx}^{*} ) \qquad Formula ( 8 )$$

The second location information of each grid vertex may be obtained by solving the formula (6) or the formula (8). Then, at least one motion parameter of a second speed, a second acceleration, or a second momentum of each grid vertex is determined based on the second location information of each grid vertex, to obtain the second motion information of each grid vertex. The motion of the grid vertex at the second moment is described through the second motion information of the grid vertex, where a difference between the second moment and the first moment is the motion time h. It can be learned from the foregoing description that, the second motion information of the grid vertex represents the motion state of the grid vertex at the second moment, and the motion state of the grid vertex at the second moment includes at least one of a location, a speed, an acceleration, or a momentum of the grid vertex at the second moment.

In some examples, when the second motion information of the grid vertex includes the second location information, the represented motion state includes the location of the grid vertex at the second moment. When the second motion information includes the second speed, the represented motion state includes the speed of the grid vertex at the second moment. When the second motion information includes the second acceleration, the represented motion state includes the acceleration of the grid vertex at the second moment. When the second motion information includes the second momentum, the represented motion state includes the momentum of the grid vertex at the second moment.

In a possible implementation, operation 204 includes operation 2041 to operation 2042 (not shown).

Operation 2041: Obtain a first value of the second deformation gradient of each triangular facet based on the first motion information of each grid vertex and the elastic energy function of the background grid.

As mentioned above, the target function is a function related to the location variable of the grid vertex and the second deformation gradient of the triangular facet. The target function includes the reference energy function of the background grid and the elastic energy function of the background grid. The reference energy function of the background grid is a function related to the location variable of the grid vertex, and the elastic energy function of the background grid is a function related to the second deformation gradient of the triangular facet. In an example, there is a correspondence between the first motion information, the elastic energy function, and the first value. Then operation 2041 includes: determining a first value corresponding to the first motion information of each grid vertex and the elastic energy function as the first value of the second deformation gradient of each triangular facet. In another example, operation 2041 includes: solving the elastic energy function of the background grid according to the first motion information of each grid vertex, to obtain a first value of the second deformation gradient of each triangular facet. When the target function is solved, the reference energy function of the background grid may be fixed by fixing the first motion information of each grid vertex, and only the elastic energy function of the background grid is solved. By minimizing the value of the elastic energy function of the background grid, the first value of the second deformation gradient of each triangular facet is obtained. That is, the first value {R^{f}} of the second deformation gradient of each triangular facet is obtained by solving

$${min}_{\{ {R}^{f} \}} {\sum }_{f ∈ all triangular facets} {C}_{st}^{f} {A}_{f} {‖ {F}^{f} - {R}^{f} ‖}^{2} {or min}_{\{ {R}^{f} \}} {\sum }_{f ∈ all triangular facets} {C}_{st}^{f} {A}_{f} {‖ {F}^{f} - {R}^{f} ‖}^{2} + {C}_{b d} \frac{1}{2} {{x}^{*}}^{T} {Qx}^{*} .$$

The foregoing operation involves solving the elastic energy function of the background grid in the target function, which corresponds to performing a local solution on the target function. Based on this, in a case that operation 2041 includes solving the elastic energy function of the background grid, operation 2041 may also be referred to as a local solution operation (Local Step).

Operation 2042: Obtain second motion information of each grid vertex based on the first value of the second deformation gradient of each triangular facet and the target function.

In this embodiment of this disclosure, the elastic energy function of the background grid is fixed by fixing the first value {R^{f}} of the second deformation gradient of each triangular facet. In a case that the elastic energy function of the background grid is fixed, the target function is a function related to the location variable of the grid vertex. In an example, there is a correspondence between the first value, the target function, and the second motion information. The first value of the second deformation gradient of each triangular facet and the second motion information corresponding to the target function are determined as the second motion information of each grid vertex. In another example, operation 2042 includes: solving the target function according to the first value of the second deformation gradient of each triangular facet, to obtain the second motion information of each grid vertex. Therefore, the second location information of each grid vertex may be obtained by solving the target function, and then the second motion information of each grid vertex is determined based on the second location information of each grid vertex.

In a possible implementation, the first motion information of each grid vertex includes first location information of each grid vertex, and the second motion information of each grid vertex includes a second speed and second location information of each grid vertex. Operation 2042 includes: obtaining the second location information of each grid vertex based on the first value and the target function; and determining the second speed of each grid vertex based on the first location information and the second location information of each grid vertex. In an example, the obtaining the second location information of each grid vertex based on the first value and the target function includes: solving the target function according to the first value of the second deformation gradient of each triangular facet, to obtain the second location information of each grid vertex. In another example, there is a correspondence between the first value, the target function, and the second location information. The first value of the second deformation gradient of each triangular facet and the second location information corresponding to the target function are determined as the second location information of each grid vertex.

In this embodiment of this disclosure, in a case that the elastic energy function of the background grid is fixed, the value of the target function is minimized, to obtain the second location information of each grid vertex.

That is, the second motion information xⁿ⁺¹ of each grid vertex is obtained by solving

$${min}_{{x}^{*}} \frac{1}{2} {( {x}^{*} - {s}^{n} )}^{T} M ( {x}^{*} - {s}^{n} ) + {h}^{2} {\sum }_{f ∈ all triangular facets} {C}_{st}^{f} {A}_{f} {‖ {F}^{f} - {R}^{f} ‖}^{2} or {min}_{{x}^{*}} \frac{1}{2} {( {x}^{*} - {s}^{n} )}^{T} M ( {x}^{*} - {s}^{n} ) + {h}^{2} ( {\sum }_{f ∈ all triangular facets} {C}_{st}^{f} {A}_{f} {‖ {F}^{f} - {R}^{f} ‖}^{2} + {C}_{b d} \frac{1}{2} {{x}^{*}}^{T} {Qx}^{*} ) .$$

Then, according to

$${v}^{n + 1} = \frac{{x}^{n + 1} - {x}^{n}}{h} ,$$

the second speed vⁿ⁺¹ of each grid vertex is determined according to the first location information xⁿ of each grid vertex, the second location information xⁿ⁺¹ of each grid vertex, and the motion time h.

In this embodiment of this disclosure, at least one motion parameter of the second acceleration or the second momentum of each grid vertex may be further determined based on at least one of the first location information, the second location information, the first speed, or the second speed of each grid vertex. A determination manner is not described herein again. The second motion information of the grid vertex includes at least one motion parameter of second location information, a second speed, a second acceleration, or a second momentum of the grid vertex.

The foregoing operation involves solving the target function, which is equivalent to performing a global solution on the target function. Based on this, in a case that operation 2042 includes solving the target function, operation 2042 may also be referred to as a global solution operation (Global Step).

In this embodiment of this disclosure, solving the target function belongs to a quadratic optimization problem, and the quadratic optimization problem is equivalent to solving a linear equation system. It may be assumed that the first deformation gradient F^{f} of the triangular facet satisfies: F^{f}=D^{f}x*, D^{f}: R³ⁿ→R^{3×2}, where D^{f} is a mapping function, configured for mapping the location variable x* of each grid vertex to the first deformation gradient F^{f} of the triangular facet. The location variable x* of each grid vertex is a 3n-dimensional matrix formed by real numbers, n represents the number of grid vertices, and the first deformation gradient F^{f} of the triangular facet is a 3×2-dimensional matrix formed by real numbers. When the grid facet is in a square shape, the area of the triangular facet satisfies

$${A}_{f} = \frac{{s}^{2}}{2} .$$

Solving the formula (6) mentioned above is equivalent to solving a linear equation system shown in the following formula (9).

$$( M + {( s h )}^{2} {\sum }_{f} {{C}_{st}^{f} ( {D}^{f} )}^{T} {D}^{f} ) x = M {s}^{n} + {( s h )}^{2} {\sum }_{f} {{C}_{st}^{f} ( {D}^{f} )}^{T} {R}^{f} \qquad Formula ( 9 )$$

Solving the formula (8) mentioned above is equivalent to solving a linear equation system shown in the following formula (10).

$$( M + {( s h )}^{2} {\sum }_{f} {{C}_{st}^{f} ( {D}^{f} )}^{T} {D}^{f} + {h}^{2} {C}_{b d} Q ) x = M {s}^{n} + {( s h )}^{2} {\sum }_{f} {{C}_{st}^{f} ( {D}^{f} )}^{T} {R}^{f} \qquad Formula ( 10 )$$

Meanings of parameters in the formula (9) and the formula (10) are correspondingly described above, and details are not described herein again. Msⁿ is a constant matrix. That is, elements in the matrix are all determined values, with no unknown parameters.

As mentioned earlier, the operation of solving the target function includes the local solution operation and the global solution operation.

The local solution operation is equivalent to: under the current configuration, computing a closest rigid transformation result

$${min}_{{R}^{f} ∈ SU 3 \times 2} {‖ {F}^{f} - {R}^{f} ‖}^{2}$$

for each triangular facet to obtain the first value R^{f} of the second deformation gradient of each triangular facet.

Because computation needs to be performed on each triangular facet, and the triangular facet is a facet included in grid facets obtained through uniform division, the triangular facets are the same in size, shape, and the like. It can be known according to the elastic energy function of the background grid that the elastic energy function of the background grid includes the elastic energy density of each triangular facet. Based on this, when operation 2041 is implemented, the background grid may be divided into a plurality of sub-regions and any one of the plurality of sub-regions includes at least one triangular facet. The first value of the second deformation gradient of each triangular facet in the background grid is obtained based on parallel computational resources associated with the sub-regions of the plurality of sub-regions. The first value of the second deformation gradient of each triangular facet in the background grid is obtained based on the elastic energy density of the at least one triangular facet in each sub-region and the first motion information of each grid vertex in the background grid. For example, the elastic energy density of the triangular facet included in each sub-region is solved in parallel by using the computational resources corresponding to each sub-region, to obtain the first value of the second deformation gradient of each triangular facet.

For example, the triangular facets may be first divided into a plurality of groups, with each group including at least one triangular facet. That is, the background grid is divided into a plurality of sub-regions, and the triangular facets in a group are those within a single sub-region of the background grid. Next, corresponding computational resources are allocated to each sub-region. The computational resources may be a processor, a thread, or the like. According to the first motion information of each grid vertex, the computational resources are used to solve, in a parallel computing manner, the elastic energy density of each triangular facet within the corresponding sub-region, thereby obtaining the first value of the second deformation gradients of each triangular facet. For any sub-region, the computational resources corresponding to the sub-region are used to solve the elastic energy density of the triangular facet in the sub-region according to the first motion information of each grid vertex of the triangular facet in the sub-region, and accordingly the first value of the second deformation gradient of the triangular facet in the sub-region is obtained. Because the background grid is obtained through uniform division, the background grid may be easily divided into a plurality of sub-regions. Through parallel computation, the computation efficiency is increased, and the real-time performance of cloth simulation is enhanced.

The global solution operation may correspond to searching for a configuration satisfying a condition 1 and a condition 2.

Condition 1: there is an inertia in which a result is expected to proceed along a previous constant speed, namely satisfying

$$\frac{1}{2} {( {x}^{*} - {s}^{n} )}^{T} M ( {x}^{*} - {s}^{n} ) .$$

Condition 2: it ensures that a deformation result of each triangular facet is as close as possible to a transformation determined in the local solution operation, namely satisfying Σ_{f∈all triangular facets}

$${C}_{st}^{f} {A}_{f} {‖ {F}^{f} - {R}^{f} ‖}^{2} .$$

Different electronic devices correspond to different computational resources, and the availability of the computational resources of the same electronic device may change in real time. In this embodiment of this disclosure, uniform division is performed on the two-dimensional plane in which the cloth model in the flattened state is located, to obtain a fine grid. When the available computational resources of the electronic device are not lower than a threshold, the fine grid is used as the background grid mentioned above. When the available computational resources of the electronic device are lower than the threshold, uniform sampling may be performed on the fine grid, to obtain a coarse grid, and the coarse grid is used as the background grid mentioned above. A grid density of the fine grid is greater than that of the coarse grid. In other words, the number of fine grids included in a two-dimensional plane of the same area is greater than that of coarse grids. Because the fine grid is obtained through uniform division and has a simple topological structure, and the coarse grid is obtained by performing uniform sampling on the fine grid, the electronic device can simply perform switching between the coarse grid and the fine grid, thereby adaptively switching the grid density according to the computational resources of the electronic device.

If the background grid is the coarse grid, second motion information of each grid vertex in the fine grid may be determined based on second motion information of each grid vertex in the coarse grid in an interpolation manner, and then second pose information of the cloth model is determined based on the second motion information of each grid vertex in the fine grid.

In a possible implementation, after operation 2042, the method further includes: obtaining a second value of the second deformation gradient of each triangular facet based on the second motion information of each grid vertex and the elastic energy function; obtaining third motion information of each grid vertex based on the second value of the second deformation gradient of each triangular facet and the target function, the third motion information of the grid vertex representing a motion state of the grid vertex at a third moment (for example, time t3) after the second moment; and determining second pose information of the cloth model based on the third motion information of each grid vertex.

In an example, the obtaining a second value of the second deformation gradient of each triangular facet based on the second motion information of each grid vertex and the elastic energy function includes: solving the elastic energy function of the background grid according to the second motion information of each grid vertex, to obtain the second value of the second deformation gradient of each triangular facet. In some examples, there is a correspondence between the second motion information, the elastic energy function, and the second value. The second value corresponding to the second motion information of each grid vertex and the elastic energy function may be determined as the second value of the second deformation gradient of each triangular facet.

In an example, the obtaining third motion information of each grid vertex based on the second value of the second deformation gradient of each triangular facet and the target function includes: solving the target function according to the second value of the second deformation gradient of each triangular facet, to obtain the third motion information of each grid vertex. In some examples, there is a correspondence between the second value, the target function, and the third motion information. The second value of the second deformation gradient of each triangular facet and the third motion information corresponding to the target function may be determined as the third motion information of each grid vertex.

In some examples, the third motion information of the grid vertex includes at least one motion parameter of third location information, a third speed, a third acceleration, or a third momentum. The motion state of the grid vertex at the third moment includes at least one of a location, a speed, an acceleration, or a momentum of the grid vertex at the third moment. When the third motion information of the grid vertex includes the third location information, the represented motion state includes the location of the grid vertex at the third moment. When the third motion information includes the third speed, the represented motion state includes the speed of the grid vertex at the third moment. When the third motion information includes the third acceleration, the represented motion state includes the acceleration of the grid vertex at the third moment. When the third motion information includes the third momentum, the represented motion state includes the momentum of the grid vertex at the third moment.

In this embodiment of this disclosure, if the second motion information of each grid vertex satisfies a target condition, the target function may be solved based on the second motion information of each grid vertex, to obtain the third motion information of each grid vertex. The motion made by the grid vertex at the third moment is described through the third motion information of the grid vertex, and a difference between the third moment and the second moment is a motion time. This embodiment of this disclosure does not limit content of the target condition that the second motion information of each grid vertex satisfies.

In some embodiments, the second motion information of the grid vertex includes at least one motion parameter, and if a value of each motion parameter is not less than a corresponding threshold, it is determined that the second motion information of the grid vertex satisfies the target condition. In some examples, the electronic device acquires a first iteration count, updates the first iteration count to obtain a second iteration count when determining the second motion information of each grid vertex, and determines that the second motion information of each grid vertex satisfies the target condition if the second iteration count is not greater than an iteration count threshold.

When solving the target function based on the second motion information of each grid vertex to obtain the third motion information of each grid vertex, the electronic device may first fix the second motion information of each grid vertex, to fix the reference energy function of the background grid, and solve only the elastic energy function of the background grid. By minimizing the value of the elastic energy function of the background grid, the second value of the second deformation gradient of each triangular facet is obtained. Then, the elastic energy function of the background grid is fixed by fixing the second value of the second deformation gradient of each triangular facet. In a case that the elastic energy function of the background grid is fixed, the target function is a function related to the location variable of the grid vertex. Therefore, the third location information of each grid vertex may be obtained by solving the target function, and then the third motion information of each grid vertex is determined based on the third location information of each grid vertex. For an implementation of the foregoing content, reference may be made to the descriptions of operation 2041 to operation 2042. Details are not described herein again.

Then, the second pose information of the cloth model is determined based on the third motion information of each grid vertex. For a manner for determining the second pose information, reference may be made to the description of operation 205, with similar implementation principles. Details are not described herein again.

Next, if the third motion information of each grid vertex satisfies the target condition, the target function may be solved based on the third motion information of each grid vertex, to obtain fourth motion information of each grid vertex. In some examples, the fourth motion information of the grid vertex represents a motion state of the grid vertex at a fourth moment. In an example, the fourth moment is later than the third moment. The fourth motion information of the grid vertex includes at least one motion parameter of fourth location information, a fourth speed, a fourth acceleration, or a fourth momentum. The motion state of the grid vertex at the fourth moment includes at least one of a location, a speed, an acceleration, or a momentum of the grid vertex at the fourth moment. When the fourth motion information of the grid vertex includes the fourth location information, the represented motion state includes the location of the grid vertex at the fourth moment. When the fourth motion information includes the fourth speed, the represented motion state includes the speed of the grid vertex at the fourth moment. When the fourth motion information includes the fourth acceleration, the represented motion state includes the acceleration of the grid vertex at the fourth moment. When the fourth motion information includes the fourth momentum, the represented motion state includes the momentum of the grid vertex at the fourth moment.

Then, third pose information of the cloth model is determined based on the fourth motion information of each grid vertex. The content of the target condition that the third motion information of each grid vertex satisfies is similar to the content of the target condition that the second motion information of each grid vertex satisfies. For a manner for determining the third pose information, reference may be made to the description of operation 205, and details are not described herein again.

For a target function to-be-solved

$${argmin}_{{x}^{*}} \frac{1}{2} {( {x}^{*} - {s}^{n} )}^{T} M ( {x}^{*} - {s}^{n} ) + {h}^{2} {E}_{e l s} ( {x}^{*} ) ,$$

convexity of the target function may be avoided by setting a small motion time h. If the motion time is h→0, the target function may degenerate into the quadratic optimization problem. In this case, a small iteration count threshold may be set, such that the target function can be well converged.

In this embodiment of this disclosure, the elastic motion of the cloth model is simulated through the background grid. Because the background grid is obtained through uniform division and the grid facets have the same shape and size, the electronic device may perform solving in parallel and efficiently, to quickly determine the motion information of the grid vertices. In addition, the background grid naturally supports multi-physical field coupling. When the cloth interacts with another object, the cloth model is simulated through the background grid, to quickly determine the motion information of the grid vertices, thereby quickly solving the pose of the cloth model, improving the computation efficiency, and ensuring the real-time performance of cloth simulation.

Operation 205: Determine first pose information of the cloth model based on the second motion information of each grid vertex.

In this embodiment of this disclosure, by endowing the background grid with the same elastic performance, motion state, etc. as those of the cloth model, the motion of the cloth model is simulated through the background grid. Therefore, the motion information of each grid vertex in the background grid is related to the motion information of each cloth vertex in the cloth model. The second motion information of each cloth vertex in the cloth model may be determined based on the second motion information of each grid vertex in the background grid. The first pose information of the cloth model includes the second motion information of each cloth vertex.

In this embodiment of this disclosure, the elastic motion of the cloth model is first simulated through the background grid to obtain the second motion information of each grid vertex, and then the second motion information of each cloth vertex is determined through the second motion information of each grid vertex, thereby combining the cloth simulation based on the background grid and the cloth vertex motion solving. This solving method belongs to a particle-grid method. When the cloth simulation is performed through the particle-grid method, a collision item does not need to be additionally considered, thereby reducing a computation amount, and thus automatically processing complex cloth collision and friction.

In a possible implementation, the cloth model includes a plurality of cloth vertices. Operation 205 includes operation 2051 to operation 2053 (not shown).

Operation 2051: Determine, for any cloth vertex, second motion information of one grid vertex as second motion information of the any cloth vertex in a case that the any grid vertex overlaps with one cloth vertex.

In this embodiment of this disclosure, after the background grid is obtained by uniformly dividing the two-dimensional plane in which the cloth model in the flattened state is located, any grid vertex in the background grid may overlap with one cloth vertex in the cloth model, or may not overlap any cloth vertex. If one grid vertex overlaps with one cloth vertex, the second motion information of the grid vertex is the second motion information of the cloth vertex.

Operation 2052: Determine a grid vertex related to the any cloth vertex from the plurality of grid vertices in a case that the any grid vertex does not overlap with one cloth vertex, and perform interpolation on the second motion information of the grid vertex related to the any cloth vertex, to obtain the second motion information of the any cloth vertex.

If one grid vertex does not overlap with any cloth vertex, the plurality of grid vertices around one cloth vertex in the cloth model in the flattened state in the background grid are grid vertices related to the cloth vertex, and interpolation is performed on the second motion information of each grid vertex related to the cloth vertex, to obtain the second motion information of the cloth vertex.

The second motion information of the cloth vertex also includes at least one motion parameter of a second speed, second location information, a second acceleration, or a second momentum of the cloth vertex, and these motion parameters are configured for describing a motion made by the cloth vertex. This embodiment of this disclosure does not limit a manner for performing interpolation on the second motion information of each grid vertex. In some examples, the interpolation is performed on the second motion information of each grid vertex by using at least one of the nearest neighbor interpolation method, the bilinear interpolation method, or the quadratic B-spline interpolation method.

Operation 2053: Determine first pose information of the cloth model based on the second motion information of each cloth vertex.

In this embodiment of this disclosure, the first pose information of the cloth model includes the second motion information of each cloth vertex. A static pose of the cloth model, such as a shape, stretching, and distortion, may be determined through the second location information of each cloth vertex. A dynamic pose of the cloth model may be determined through the motion parameters, such as the second speed, the second acceleration, and the second momentum of each cloth vertex.

In some embodiments, operation 2053 includes: for any cloth facet included in the cloth model, determining second motion information of reference points on the any cloth facet based on second motion information of at least two cloth vertices in the any cloth facet, the any cloth facet including a plurality of cloth vertices; and determining first pose information of the cloth model based on the second motion information of each cloth vertex and the second motion information of each reference point.

In this embodiment of this disclosure, the cloth model includes a plurality of cloth facets, and any cloth facet has at least one reference point. This embodiment of this disclosure does not limit the reference point. In some examples, the reference point may be a midpoint on an upper side of the cloth facet, or the reference point may be a center of gravity of the cloth facet, or the like.

Next, the second motion information of each reference point on the cloth facet may be determined based on the second motion information of the at least two cloth vertices in the cloth facet. Different relationships between the reference points and the cloth facets result in varying manners for determining the second motion information of the reference points. For example, an example in which the reference point is the midpoint on the upper side of the cloth facet is used, an average value of the second motion information of two cloth vertices at two ends of the upper side of the cloth facet may be calculated, and the average value is used as the second motion information of the reference point. For another example, an example in which the reference point is the center of gravity of the cloth facet is used. First, the second location information of the reference point may be determined based on the second location information of each cloth vertex on the cloth facet. This operation is equivalent to determining coordinates of the center of gravity of the cloth facet. Next, the second motion information of the reference point is determined based on the second location information of the reference point and the second motion information of each cloth vertex on the cloth facet.

The second motion information of the reference point includes at least one motion parameter of second location information, a second speed, a second acceleration, or a second momentum of the reference point. The first pose information of the cloth model includes the second motion information of each cloth vertex and the second motion information of each reference point. By determining the second motion information of the reference points, points inside the cloth facet are added, to implement more detailed division of the cloth model, such that the cloth model is represented in more detail, thereby improving expressiveness of the cloth model.

In the foregoing method, the two-dimensional plane in which the cloth model (e.g., in the flattened state) is located is uniformly divided to obtain the background grid, the target function is constructed based on the elastic energy function of the background grid and the first motion information of each grid vertex in the background grid, and the second motion information of each grid vertex is obtained based on the target function (e.g., by solving the target function), thereby simulating the motion of the cloth model through the background grid. Because the background grid is obtained through uniform division, the grid vertices in the background grid have the same shape, size, etc., and a topological structure of the background grid is simple, which can accelerate the efficiency of computing the second motion information of the grid vertices. Then, the first pose information of the cloth model is determined based on the second motion information of each grid vertex, such that a motion result of the background grid is transferred back to the cloth model, thereby quickly and accurately obtaining a pose of the cloth model, and enhancing real-time performance of cloth simulation.

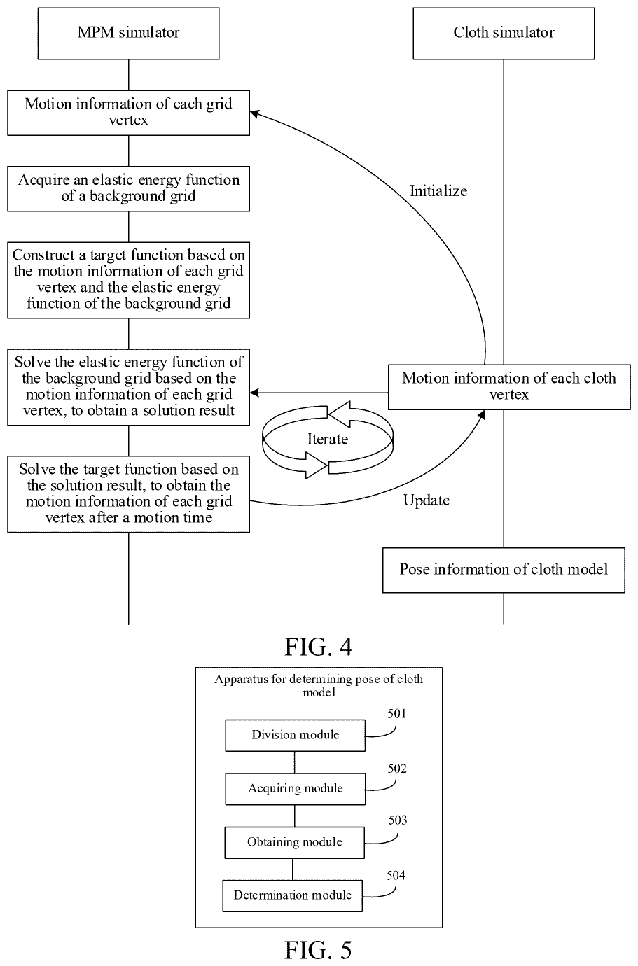

The content of this embodiment of this disclosure is described above from the perspective of method operations. The following is a systematic and comprehensive description in combination with FIG. 4. FIG. 4 is a flowchart of another method for determining pose information of a cloth model according to an embodiment of this disclosure. As shown in FIG. 4, this embodiment of this disclosure includes a cloth simulator and a material point method (MPM) simulator. The cloth simulator is configured to simulate the cloth model, can determine motion information of each cloth vertex, and determine the pose information of the cloth model based on the motion information of each cloth vertex. The MPM simulator is configured to simulate the cloth model on a background grid, and obtain motion information of each grid vertex by constructing a target function and solving the target function. The following is a detailed description of the cloth simulator and the MPM simulator.

In this embodiment of this disclosure, the cloth simulator and the MPM simulator may be configured on an electronic device. The cloth simulator may be initialized based on initial pose information of the cloth model, such that the cloth simulator can acquire motion information of each cloth vertex. Next, the MPM simulator is initialized according to the motion information of each cloth vertex, such that the MPM simulator can acquire the motion information of each grid vertex in the background grid, thereby simulating a pose of the cloth model in the cloth simulator through the background grid in the MPM simulator. The MPM simulator acquires an elastic energy function of the background grid, and constructs the target function based on the motion information of each grid vertex and the elastic energy function of the background grid.

Next, the MPM simulator solves the elastic energy function of the background grid according to the motion information of each grid vertex, to obtain a solution result, and solves the target function based on the solution result, to obtain the motion information of each grid vertex. Then, the cloth simulator updates the motion information of each cloth vertex based on the motion information of each grid vertex, and determines the pose information of the cloth model based on the motion information of each cloth vertex. The foregoing operations are performed iteratively.

That is, after the target function is constructed, the MPM simulator performs multi-operation iterative solving on the target function. After each operation of iterative solving, the motion information of each cloth vertex is updated based on the motion information of each grid vertex, to update the pose information of the cloth model.

Through the MPM simulator and the cloth simulator, the motion of the cloth model is simulated through the background grid, the motion information of each cloth vertex in the cloth model is interpolated to the background grid, cloth elasticity computation is performed on the background grid to obtain motion information of the background grid, and then the motion information of the background grid is interpolated back to the cloth model. Through information transfer between the MPM simulator and the cloth simulator, the elasticity computation is first performed on the background grid without the need for additional penalty terms. Then, a collision result of the cloth model is determined based on an elasticity computation result, such that the elasticity computation and collision solving are respectively processed in different simulators, thereby improving the computation efficiency.

Because the background grid is obtained through uniform division, the elasticity computation may be performed in parallel, thereby accelerating the computation efficiency and ensuring realness of simulation while implementing real-time simulation. The method in this embodiment of this disclosure may be applied to a game engine. The game engine may perform quick resolution on collision between the cloth model and an object model such as another cloth model, a rigid body model, or an elastic body model, to ensure the real-time performance of cloth simulation.

FIG. 5 is a schematic structural diagram of an apparatus for determining pose information of a cloth model according to an embodiment of this disclosure. As shown in FIG. 5, the apparatus includes a division module 501, an acquiring module 502, an obtaining module 503, and a determining module 504.

The division module 501 is configured to uniformly divide a two-dimensional plane in which the cloth model in a flattened state is located to obtain a background grid. In some examples, the division module 501 is configured to uniformly divide a two-dimensional plane to obtain a background grid, the two-dimensional plane including the cloth model, and the cloth model being capable of presenting the flattened state.

The acquiring module 502 is configured to acquire first motion information of each grid vertex in the background grid, the first motion information of the grid vertex representing a motion state of the grid vertex at a first moment.

The acquiring module 502 is further configured to acquire an elastic energy function of the background grid, the elastic energy function of the background grid being configured for describing stored energy in a case that the background grid has elastic performance of the cloth model, or the elastic energy function being configured for describing an elastic energy parameter of the background grid, and the elastic energy parameter being configured for the background grid to simulate the cloth model with corresponding elastic performance, or the elastic energy function describing elasticity of the cloth model by using the elastic energy parameter. The acquiring module 502 is further configured to acquire a target function configured for constraining the elastic energy function of the background grid and the first motion information of each grid vertex.

The obtaining module 503 is configured to obtain second motion information of each grid vertex based on the target function. For example, the obtaining module 503 corresponds to a solving module configured to solve the target function, and to obtain the second motion information of each grid vertex, the second motion information of the grid vertex representing a motion state of the grid vertex at a second moment after the first moment. In some examples, the solving module is configured to solve the target function, and to obtain the second motion information of each grid vertex. The second motion information of the grid vertex represents the motion state of the grid vertex at the second moment, and the second moment being later than the first moment.

The determining module 504 is configured to determine first pose information of the cloth model based on the second motion information of each grid vertex.

In a possible implementation, the cloth model includes a plurality of cloth vertices. The acquiring module 502 is configured to determine, for any grid vertex, first motion information of one cloth vertex as first motion information of the any grid vertex in a case that the any grid vertex overlaps with one cloth vertex; and determine a cloth vertex (i.e., a reference cloth vertex) related to the any grid vertex from the plurality of cloth vertices in a case that the any grid vertex does not overlap with one cloth vertex, and perform interpolation on the first motion information of the cloth vertex related to the any grid vertex, to obtain first motion information of the any grid vertex.

In a possible implementation, the acquiring module 502 is configured to determine an elastic energy function of the background grid based on an elastic performance parameter of the cloth model and the first motion information of each grid vertex, where the elastic performance parameter includes at least one of a tensile strength or an elastic modulus, and the first motion information includes at least one motion parameter of first location information, a first speed, a first acceleration, or a first momentum.

In a possible implementation, the background grid includes a plurality of grid facets, any grid facet includes a plurality of grid vertices and any grid facet includes at least one triangular facet, with the vertices of any triangular facet being the grid vertices.

The acquiring module 502 is configured to determine, for any triangular facet, an elastic energy density of the any triangular facet based on a tensile strength of the any triangular facet and first location information of each grid vertex in the any triangular facet, the elastic energy density of the any triangular facet representing elastic energy stored in the any triangular facet, or, the elastic energy density of the any triangular facet being configured for describing elasticity of a sub-cloth model, the elastic energy density of the any triangular facet being configured for the any triangular facet to simulate the sub-cloth model with corresponding elastic performance, and the sub-cloth model being a part corresponding to any triangular facet in the cloth model; and determine an elastic energy function of the background grid based on the elastic energy density of each triangular facet. The elastic performance parameter includes the tensile strength, and the first motion information includes the first location information.

In a possible implementation, the acquiring module 502 is configured to determine an area and a first deformation gradient of any triangular facet based on first location information of each grid vertex in the any triangular facet; determine a second deformation gradient of the any triangular facet based on the first deformation gradient of the any triangular facet, the second deformation gradient of the any triangular facet representing a deformation gradient obtained after performing a value constraint on the first deformation gradient of the any triangular facet; and determine an elastic energy density of the any triangular facet based on the tensile strength, the area, the first deformation gradient, and the second deformation gradient of the any triangular facet.

In a possible implementation, the acquiring module 502 is configured to determine a length of each side in the any triangular facet based on the first location information of each grid vertex in the any triangular facet; determine an area of the any triangular facet according to the length of each side of the any triangular facet; and determine a first deformation gradient of the any triangular facet according to the length of each side in the any triangular facet and the first location information of each grid vertex in the any triangular facet.

In a possible implementation, two sides in any triangular facet are perpendicular to each other and have the same length; and the length of each side in the any triangular facet includes a length of a target side, and the target side is one of the two sides that are perpendicular to each other and have the same length. The acquiring module 502 is configured to determine the length of the target side based on the first location information of each grid vertex in the any triangular facet, the target side being one of the two sides that are perpendicular to each other and have the same length; determine an area of the any triangular facet based on the length of the target side; and determine a first deformation gradient of the any triangular facet based on the length of the target side and the first location information of each grid vertex in the any triangular facet.

In a possible implementation, the acquiring module 502 is configured to perform singular value decomposition on the first deformation gradient of any triangular facet, to obtain a first orthogonal matrix, a first diagonal matrix, and a second orthogonal matrix; replace the first diagonal matrix with a second diagonal matrix, the second diagonal matrix representing a matrix obtained after performing the value constraint on the first diagonal matrix; and determine a second deformation gradient of the any triangular facet based on the first orthogonal matrix, the second diagonal matrix, and the second orthogonal matrix.

In a possible implementation, the acquiring module 502 is configured to add the elastic energy densities of the plurality of triangular facets in a case that the cloth model does not have a bending effect, to obtain an elastic energy function of the background grid; acquire a bending strength and a mean curvature of the cloth model in a case that the cloth model has the bending effect; and determine the elastic energy function of the background grid based on the bending strength and the mean curvature of the cloth model, and the elastic energy density of each triangular facet.

In a possible implementation, the acquiring module 502 is configured to determine a reference location of each grid vertex based on the first motion information of each grid vertex and a gravitational acceleration, the reference location of any grid vertex being configured for describing a location of the any grid vertex after the motion under the influence of gravity; determine a reference energy function of the background grid that is configured for constraining a cloth mass corresponding to the cloth model and the reference location of each grid vertex; and construct a target function based on the reference energy function of the background grid and the elastic energy function of the background grid.

In a possible implementation, the obtaining module 503 is configured to obtain a first value of the second deformation gradient of each triangular facet based on the first motion information of each grid vertex and the elastic energy function of the background grid; and solve the target function according to the first value of the second deformation gradient of each triangular facet, to obtain second motion information of each grid vertex. For example, when the obtaining module 503 is a solving module, the solving module is configured to solve the elastic energy function of the background grid according to the first motion information of each grid vertex, to obtain the first value of the second deformation gradient of each triangular facet.

In a possible implementation, the first motion information of each grid vertex includes first location information of each grid vertex, and the second motion information of each grid vertex includes a second speed and second location information of each grid vertex. The obtaining module 503 is configured to obtain the second location information of each grid vertex based on the first value and the target function; and determine the second speed of each grid vertex based on the first location information and the second location information of each grid vertex. For example, when the obtaining module 503 is the solving module, the solving module is configured to solve the target function according to the first value of the second deformation gradient of each triangular facet, to obtain the second location information of each grid vertex.

In a possible implementation, the obtaining module 503 is further configured to obtain a second value of the second deformation gradient of each triangular facet based on the second motion information of each grid vertex and the elastic energy function. For example, when the obtaining module 503 is the solving module, the solving module is configured to solve the elastic energy function of the background grid according to the second motion information of each grid vertex, to obtain the second value of the second deformation gradient of each triangular facet.

The obtaining module 503 is further configured to obtain third motion information of each grid vertex based on the second value of the second deformation gradient of each triangular facet and the target function, the third motion information of the grid vertex representing a motion state of the grid vertex at a third moment after the second moment. For example, when the obtaining module 503 is the solving module, the solving module is configured to solve the target function according to the second value of the second deformation gradient of each triangular facet, to obtain the third motion information of each grid vertex.

The determining module 504 is further configured to determine second pose information of the cloth model based on the third motion information of each grid vertex.

In a possible implementation, the elastic energy function of the background grid includes the elastic energy density of each triangular facet. The solving module 503 is configured to divide the background grid into a plurality of sub-regions, any one of the plurality of sub-regions including at least one adjacent triangular facet; and solve the elastic energy density of the triangular facet included in each sub-region in parallel by using computational resources corresponding to each sub-region according to the first motion information of each grid vertex, to obtain the first value of the second deformation gradient of each triangular facet. For example, the elastic energy density of the triangular facet included in each sub-region is solved in parallel by using the computational resources corresponding to each sub-region, to obtain the first value of the second deformation gradient of each triangular facet.

In a possible implementation, the cloth model includes a plurality of cloth vertices. The determining module 504 is configured to determine, for any cloth vertex, second motion information of one grid vertex as second motion information of the any cloth vertex in a case that the any grid vertex overlaps with the cloth vertex; determine a grid vertex related to the any cloth vertex from the plurality of grid vertices in a case that the any grid vertex does not overlap with one cloth vertex, and perform interpolation on the second motion information of the grid vertex related to the any cloth vertex, to obtain the second motion information of the any cloth vertex; and determine first pose information of the cloth model based on the second motion information of each cloth vertex.

In a possible implementation, the determining module 504 is configured to determine, for any cloth facet included in the cloth model, second motion information of reference points on the any cloth facet based on second motion information of at least two cloth vertices in the any cloth facet, the any cloth facet including a plurality of cloth vertices; and determine first pose information of the cloth model based on the second motion information of each cloth vertex and the second motion information of each reference point.

In the foregoing apparatus, the two-dimensional plane in which the cloth model in the flattened state is located is uniformly divided to obtain the background grid, the target function is constructed based on the elastic energy function of the background grid and the first motion information of each grid vertex in the background grid, and the second motion information of each grid vertex is obtained by solving the target function, thereby simulating the motion of the cloth model through the background grid. Because the background grid is obtained through uniform division, the grid vertices in the background grid have the same shape, size, etc., and a topological structure of the background grid is simple, which can accelerate the efficiency of computing the second motion information of the grid vertices. Then, the first pose information of the cloth model is determined based on the second motion information of each grid vertex, such that a motion result of the background grid is transferred back to the cloth model, thereby quickly and accurately obtaining a pose of the cloth model, and ensuring real-time performance of cloth simulation.

When the apparatus provided in FIG. 5 implements its functions, only division into the foregoing function modules is used as an example for description. In the practical application, the functions may be allocated to and completed by different function modules according to requirements. To be specific, an internal structure of the device is divided into different function modules, to complete all or some of the functions described above. In addition, the apparatus and method embodiments provided in the foregoing embodiments belong to the same conception. For the specific implementation process, refer to the method embodiments. Details are not described herein again.

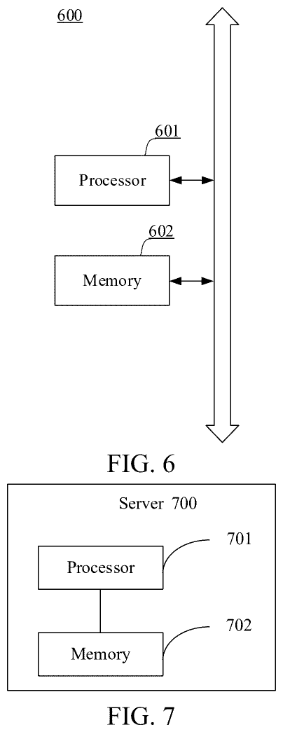

FIG. 6 is a structural block diagram of a terminal device 600 according to a non-limiting embodiment of this disclosure. The terminal device 600 includes a processor 601 and a memory 602.

Processing circuitry, such as the processor 601 may include one or more processing cores, such as a 4-core processor or an 8-core processor. The processor 601 may be implemented in at least one hardware form of digital signal processing (DSP), a field-programmable gate array (FPGA), or a programmable logic array (PLA). The processor 601 may also include a main processor and a coprocessor. The main processor is a processor configured to process data in an awake state, and is also referred to as a central processing unit (CPU). The coprocessor is a low power consumption processor configured to process data in a standby state. In some embodiments, the processor 601 may be integrated with a graphics processing unit (GPU). The GPU is configured to render and draw content that needs to be displayed on a display screen. In some embodiments, the processor 601 may further include an artificial intelligence (AI) processor. The AI processor is configured to process computing operations related to machine learning.

The memory 602 may include one or more computer-readable storage media. The computer-readable storage medium may be non-transitory (or non-temporary). The memory 602 may further include a high-speed random access memory and a nonvolatile memory, for example, one or more disk storage devices or flash storage devices. In some embodiments, the non-transitory computer-readable storage medium in the memory 602 is configured to store at least one computer program, and the at least one computer program is configured to be executed by the processor 601 to implement the method for determining pose information of a cloth model provided in the method embodiments of this disclosure.

A person skilled in the art may understand that the structure shown in FIG. 6 constitutes no limitation on the terminal device 600, and the terminal device may include more or fewer components than those shown in the figure, or some components may be combined, or a different component arrangement may be used.

FIG. 7 is a schematic structural diagram of a server according to an embodiment of this disclosure. The server 700 may vary greatly due to different configurations or performance and may include one or more processors 701 and one or more memories 702. The one or more memories 702 have at least one computer program stored therein. The at least one computer program is loaded and executed by the one or more processors 701 to implement the method for determining pose information of a cloth model provided in the foregoing method embodiments. In some examples, the processor 701 is a CPU. Of course, the server 700 may further have components such as a wired or wireless network interface, a keyboard, and an input/output interface for inputting and outputting. The server 700 may further include other components configured to implement device functions, and details are not described herein.

In a non-limiting embodiment, a non-transitory computer-readable storage medium is further provided. The non-transitory computer-readable storage medium has at least one computer program stored therein. The at least one computer program is loaded and executed by a processor to cause an electronic device to implement any one of the foregoing methods for determining pose information of a cloth model.

In some embodiments, the foregoing non-transitory computer-readable storage medium may be a read-only memory (ROM), a random access memory (RAM), a compact disc read-only memory (CD-ROM), a magnetic tape, a floppy disk, an optical data storage device, or the like.

In a non-limiting embodiment, a computer program is further provided, and there is at least one computer program. The at least one computer program is loaded and executed by a processor to cause an electronic device to implement any one of the foregoing methods for determining pose information of a cloth model.

In a non-limiting embodiment, a computer program product is further provided, having at least one computer program stored therein. The at least one computer program is loaded and executed by a processor to cause an electronic device to implement any one of the foregoing methods for determining pose information of a cloth model.

The term “plurality of” mentioned herein refers to two or more. “And/or” describes an association relationship between associated objects, and there may be three relationships. For example, A and/or B may represent: A exists alone, both A and B exist, and B exists alone. The character “/” may correspond to the associated objects before and after it being in an “or” relationship.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The sequence numbers of the foregoing embodiments of this disclosure are merely for description purposes and do not imply any preference among the embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions are merely non-limiting embodiments of this disclosure, and are not intended to limit this disclosure. Any modification, equivalent replacement, or improvement made within the principle of this disclosure shall fall within the scope of this disclosure.

What is claimed is:

1. A method for determining pose information of a cloth model, comprising:
obtaining a background grid based on uniformly dividing a two-dimensional plane, the two-dimensional plane including the cloth model;
acquiring first motion information of each grid vertex in the background grid, the first motion information indicating a motion state of each grid vertex at a first moment;
acquiring an elastic energy function of the background grid, the elastic energy function indicating elasticity of the cloth model based on an elastic energy parameter;
acquiring a target function indicating one or more constraints of the elastic energy function and the first motion information of each grid vertex in the background grid;
obtaining second motion information of each grid vertex in the background grid based on the target function, the second motion information indicating a motion state of each grid vertex at a second moment, and the second moment being later than the first moment; and
determining, by processing circuitry, first pose information of the cloth model based on the second motion information of each grid vertex.

2. The method according to claim 1, wherein
the cloth model includes a plurality of cloth vertices, and
the acquiring the first motion information includes:
determining, for a grid vertex in the background grid, first motion information of a cloth vertex in the cloth model as the first motion information of the grid vertex, when the grid vertex overlaps with the cloth vertex;
determining, for the grid vertex in the background grid, one or more reference cloth vertexes related to the grid vertex from the plurality of cloth vertices in the cloth model; and
obtaining the first motion information of the grid vertex based on first motion information of the one or more reference cloth vertexes, when the grid vertex in the background grid does not overlap with any of the plurality of cloth vertices in the cloth model.

3. The method according to claim 1, wherein the acquiring the elastic energy function comprises:
determining the elastic energy function of the background grid based on an elastic performance parameter of the cloth model and the first motion information of each grid vertex in the background grid,
the elastic performance parameter including at least one of a tensile strength or an elastic modulus, and the first motion information including at least one motion parameter of first location information, a first speed, a first acceleration, or a first momentum.

4. The method according to claim 3, wherein
the background grid includes a plurality of grid facets, each grid facet including a plurality of grid vertices, each grid facet including at least one triangular facet, and vertices of the triangular facets being the grid vertices in the background grid,
the elastic performance parameter includes the tensile strength,
the first motion information includes the first location information, and
the determining the elastic energy function of the background grid includes:
determining, for each triangular facet, an elastic energy density of the corresponding triangular facet based on the tensile strength of the corresponding triangular facet and the first location information of the grid vertexes of the corresponding triangular facet, the elastic energy density of the corresponding triangular facet indicating elasticity of a sub-cloth model, and the sub-cloth model being a part of the cloth model corresponding to the corresponding triangular facet; and
determining the elastic energy function of the background grid based on the elastic energy density of each triangular facet.

5. The method according to claim 4, wherein the determining the elastic energy density of the corresponding triangular facet comprises:
determining an area and a first deformation gradient of the corresponding triangular facet based on the first location information of each grid vertex of the corresponding triangular facet;
determining a second deformation gradient of the corresponding triangular facet based on the first deformation gradient of the corresponding triangular facet, the second deformation gradient of the corresponding triangular facet indicating a deformation gradient based on a value constraint applied to the first deformation gradient of the corresponding triangular facet; and
determining the elastic energy density of the corresponding triangular facet based on the tensile strength, the area, the first deformation gradient, and the second deformation gradient of the corresponding triangular facet.

6. The method according to claim 5, wherein the determining the area and the first deformation gradient of the corresponding triangular facet comprises:
determining a length of each side in the corresponding triangular facet based on the first location information of each grid vertex in the corresponding triangular facet;
determining the area of the corresponding triangular facet according to the length of each side of the corresponding triangular facet; and
determining the first deformation gradient of the corresponding triangular facet according to the length of each side of the corresponding triangular facet and the first location information of each grid vertex of the corresponding triangular facet.

7. The method according to claim 6, wherein the corresponding triangular facet has two sides that are perpendicular to each other and have a same length.

8. The method according to claim 5, wherein the determining the second deformation gradient of the corresponding triangular facet comprises:
obtaining a first orthogonal matrix, a first diagonal matrix, and a second orthogonal matrix based on performing singular value decomposition on the first deformation gradient of the corresponding triangular facet;
replacing the first diagonal matrix with a second diagonal matrix, the second diagonal matrix being obtained based on applying value constraint to the first diagonal matrix; and
determining the second deformation gradient of the corresponding triangular facet based on the first orthogonal matrix, the second diagonal matrix, and the second orthogonal matrix.

9. The method according to claim 4, wherein the determining the elastic energy function of the background grid comprises:
obtaining the elastic energy function of the background grid based on adding the elastic energy densities of the plurality of triangular facets, when the cloth model does not have a bending effect; and
determining the elastic energy function of the background grid based on a bending strength and a mean curvature of the cloth model, and the elastic energy density of each triangular facet, when the cloth model has the bending effect.

10. The method according to claim 1, wherein the acquiring the target function comprises:
determining a reference location of each grid vertex in the background grid based on the first motion information of each grid vertex in the background grid and a gravitational acceleration, the reference location of each grid vertex indicating a location of the corresponding grid vertex under influence of gravity;
determining a reference energy function of the background grid indicating constraints of a cloth mass corresponding to the cloth model and the reference location of each grid vertex in the background grid; and
constructing the target function based on the reference energy function and the elastic energy function of the background grid.

11. The method according to claim 1, wherein the obtaining the second motion information of each grid vertex in the background grid comprises:
obtaining a first value of a second deformation gradient of each triangular facet in the background grid based on the first motion information of each grid vertex in the background grid and the elastic energy function; and
obtaining the second motion information of each grid vertex in the background grid based on the first value and the target function.

12. The method according to claim 11, wherein
the first motion information of each grid vertex in the background grid includes first location information of each grid vertex in the background grid,
the second motion information of each grid vertex in the background grid includes a second speed and second location information of each grid vertex in the background grid, and
the obtaining the second motion information of each grid vertex in the background grid includes:
obtaining the second location information of the respective grid vertex in the background grid based on the first value and the target function; and
determining the second speed of the respective grid vertex based on the first location information and the second location information of the respective grid vertex.

13. The method according to claim 11, further comprising:
obtaining a second value of the second deformation gradient of each triangular facet in the background grid based on the second motion information of each grid vertex in the background grid and the elastic energy function of the background grid;
obtaining third motion information of each grid vertex in the background grid based on the second value of the second deformation gradient of each triangular facet in the background grid and the target function, the third motion information indicating a motion state of each grid vertex at a third moment after the second moment; and
determining second pose information of the cloth model based on third motion information of each grid vertex in the background grid.

14. The method according to claim 11, wherein
the elastic energy function of the background grid includes an elastic energy density of each triangular facet in the background grid, and
the obtaining the first value of the second deformation gradient of each triangular facet in the background grid comprises:
dividing the background grid into a plurality of sub-regions, each one of the plurality of sub-regions including at least one triangular facet; and
obtaining the first value of the second deformation gradient of each triangular facet in the background grid based on parallel computational resources associated with the sub-regions of the plurality of sub-regions, and based on the elastic energy density of the at least one triangular facet in each sub-region and the first motion information of each grid vertex in the background grid.

15. The method according to claim 1, wherein
the background grid includes a plurality of grid vertices,
the cloth model includes a plurality of cloth vertices, and
the determining the first pose information includes:
determining, for a cloth vertex in the cloth model, second motion information of one of the plurality of grid vertices in the background grid as second motion information of the cloth vertex, when the one of the plurality of grid vertices overlaps with the cloth vertex;
when none of the plurality of grid vertices overlaps with the cloth vertex,
determining one or more reference grid vertexes related to the cloth vertex from the plurality of grid vertices in the background grid, and
obtaining the second motion information of the cloth vertex based on second motion information of the one or more reference grid vertexes; and
determining the first pose information of the cloth model based on the second motion information of each cloth vertex.

16. The method according to claim 15, wherein the determining the first pose information of the cloth model based on the second motion information of each cloth vertex comprises:
determining, for each cloth facet in the cloth model, second motion information of one or more reference points on the corresponding cloth facet based on second motion information of at least two cloth vertices in the corresponding cloth facet; and
determining the first pose information of the cloth model based on the second motion information of each cloth vertex in the cloth model and the second motion information of each reference point.

17. An apparatus for determining pose information of a cloth model, comprising:
processing circuitry configured to:
obtain a background grid based on uniformly dividing a two-dimensional plane, the two-dimensional plane including the cloth model;
acquire first motion information of each grid vertex in the background grid, the first motion information indicating a motion state of each grid vertex at a first moment;
acquire an elastic energy function of the background grid, the elastic energy function indicating elasticity of the cloth model based on an elastic energy parameter;
acquire a target function indicating one or more constraints of the elastic energy function and the first motion information of each grid vertex in the background grid;
obtain second motion information of each grid vertex in the background grid based on the target function, the second motion information indicating a motion state of the grid vertex at a second moment, and the second moment being later than the first moment; and
determine first pose information of the cloth model based on the second motion information of each grid vertex.

18. The apparatus according to claim 17, wherein
the cloth model includes a plurality of cloth vertices, and
to acquire the first motion information, the processing circuitry is further configured to:
determine, for a grid vertex in the background grid, first motion information of a cloth vertex in the cloth model as the first motion information of the grid vertex, when the grid vertex overlaps with the cloth vertex; and
determine, for the grid vertex in the background grid, one or more reference cloth vertexes related to the grid vertex from the plurality of cloth vertices in the cloth model, and obtaining the first motion information of the grid vertex based on first motion information of the one or more reference cloth vertexes, when the grid vertex in the background grid does not overlap with any of the plurality of cloth vertices in the cloth model.

19. The apparatus according to claim 17, wherein
the background grid includes a plurality of grid vertices,
the cloth model includes a plurality of cloth vertices, and
to determine the first pose information, the processing circuitry is further configured to:
determine, for a cloth vertex in the cloth model, second motion information of one of the plurality of grid vertices in the background grid as second motion information of the cloth vertex, when the one of the plurality of grid vertices overlaps with the cloth vertex;
when none of the plurality of grid vertices overlaps with the cloth vertex,
determine one or more reference grid vertexes related to the cloth vertex from the plurality of grid vertices in the background grid, and
obtain the second motion information of the cloth vertex based on second motion information of the one or more reference grid vertexes; and
determine the first pose information of the cloth model based on the second motion information of each cloth vertex.

20. A non-transitory computer-readable storage medium storing instructions which when executed by a processor cause the processor to perform:
obtaining a background grid based on uniformly dividing a two-dimensional plane, the two-dimensional plane including a cloth model;
acquiring first motion information of each grid vertex in the background grid, the first motion information indicating a motion state of each grid vertex at a first moment;
acquiring an elastic energy function of the background grid, the elastic energy function indicating elasticity of the cloth model based on an elastic energy parameter;
acquiring a target function indicating one or more constraints of the elastic energy function and the first motion information of each grid vertex in the background grid;
obtaining second motion information of each grid vertex in the background grid based on the target function, the second motion information indicating a motion state of the grid vertex at a second moment, and the second moment being later than the first moment; and
determining first pose information of the cloth model based on the second motion information of each grid vertex.
